(19) United States
(12) Patent Application Publication
(10) Pub. No.: US 2026/0239301 A1
(43) Pub. Date: Aug. 13, 2026

(54) BATTERY MONITORING SYSTEM, WIRELESS COMMUNICATION PROGRAM AND WIRELESS COMMUNICATION METHOD

(71) Applicant: DENSO CORPORATION, Kariya-city (JP)

(72) Inventors: Yuto HONDA, Kariya-city (JP); Sho MATSUMOTO, Kariya-city (JP); Tadashi NAKASHIMA, Kariya-city (JP)

(73) Assignee: DENSO CORPORATION, Kariya-city (JP)

(21) Appl. No.: 19/638,363

(22) Filed: Apr. 3, 2026

Related U.S. Application Data
(63) Continuation of application No. PCT/JP2024/032658, filed on Sep. 12, 2024.

(30) Foreign Application Priority Data
Oct. 6, 2023 (JP) 2023-174396

(51) Int. Cl. H04W 72/02; H04W 4/48; H04W 76/36

(52) U.S. Cl. CPC H04W 72/02; H04W 4/48; H04W 76/36

(57) ABSTRACT

A battery monitoring system monitors battery units by transmitting and receiving battery information through wireless communication. The battery monitoring system includes a wireless apparatus configured to transmit and receive information through wireless communication using a communication channel selected from among a plurality of communication channels, and a storage apparatus configured to store a channel map in which usability of each of the plurality of communication channels is set. The wireless apparatus is configured to update the channel map based on a communication result obtained during the wireless communication and to store the updated channel map in the storage apparatus. At an activation of the wireless communication, the wireless apparatus acquires the updated channel map stored in the storage apparatus and selects the communication channel with reference to the updated channel map.

### CROSS-REFERENCE OF RELATED APPLICATIONS

This application is the U.S. bypass application of International Application No. PCT/JP2024/032658 filed on September 12, 2024, which designated the U.S. and claims priority to Japanese Patent Application No. 2023-174396 filed on October 6, 2023, and the contents of both of these are incorporated herein by reference.

### BACKGROUND

### Technical Field

The present disclosure relates to a battery monitoring system, a wireless communication program for the battery monitoring system, and a wireless communication method for the battery monitoring system.

### Description of the Related Art

Conventionally, a battery system that transmits and receives battery information using wireless communication is known. In such a battery system, a communication channel is selected from among a plurality of communication channels in accordance with a predetermined selection pattern, and data communication is performed. In some battery systems, the selection pattern is changed based on communication results so that an appropriate communication channel can be selected in accordance with the surrounding environment.

### SUMMARY

The present disclosure provides a battery monitoring system, a wireless communication program, and a wireless communication method capable of reducing communication errors.

A first aspect for solving the above-described issue provides a battery monitoring system for monitoring battery units by transmitting and receiving battery information through wireless communication, the battery monitoring system including a wireless apparatus configured to transmit and receive information through wireless communication using a communication channel selected from among a plurality of communication channels, and a storage apparatus configured to store a channel map in which usability of each of the plurality of communication channels is set. The wireless apparatus is configured to update the channel map based on a communication result obtained during the wireless communication and to store the updated channel map in the storage apparatus. At an activation of the wireless communication, the wireless apparatus acquires the updated channel map stored in the storage apparatus and selects the communication channel with reference to the updated channel map.

### BRIEF DESCRIPTION OF THE DRAWINGS

The above-described objects and other objects, features and advantages of the present disclosure will be clarified further by the following detailed description with reference to the accompanying drawings. The drawings are:

FIG. 1 is a block diagram showing an overall configuration of a vehicle;

FIG. 2 is a block diagram showing the configuration of a battery pack;

FIG. 3 is a perspective view showing the overall configuration of the battery pack;

FIG. 4 is a flowchart showing a process of data communication;

FIG. 5 is a flowchart showing a process of data communication;

FIG. 6 is a flowchart showing a process of connection processing;

FIG. 7 is a diagram showing frequency bands of communication channels;

FIG. 8 is a diagram showing a data flow at the time of connection establishment;

FIG. 9 is a diagram showing an example of a channel map;

FIG. 10 is a flowchart of a disconnection process;

FIG. 11 is a flowchart showing the flow of a disconnection process according to a second embodiment;

FIG. 12 is a flowchart showing the flow of a disconnection process according to a third embodiment;

FIG. 13 is a flowchart showing the flow of a disconnection process according to a fourth embodiment;

FIG. 14 is a flowchart showing the flow of connection processing according to a fifth embodiment;

FIG. 15 is a flowchart showing the flow of data communication according to the fifth embodiment; and

FIG. 16 is a flowchart showing the flow of connection processing according to a sixth embodiment.

### DETAILED DESCRIPTION OF THE PREFERRED EMBODIMENTS

Conventionally, for example, Japanese Patent No.6514694 discloses a battery system that transmits and receives battery information using wireless communication is known. In such a battery system, a communication channel is selected from among a plurality of communication channels in accordance with a predetermined selection pattern, and data communication is performed. In some battery systems, the selection pattern is changed based on communication results so that an appropriate communication channel can be selected in accordance with the surrounding environment.

Incidentally, even when the selection pattern is changed based on communication results, the selection pattern for the communication channels is predetermined at the start of communication. Therefore, for a certain period after communication begins, it is not possible to appropriately select a communication channel according to the surrounding environment, and communication errors tend to increase.

Hereinafter, with reference to the drawings, embodiments of the battery monitoring system, the wireless communication program, and the wireless communication method according to the present disclosure will be described in detail. In the respective embodiments and modifications, the same or corresponding parts in the drawings are denoted by the same reference numerals, and repeated description thereof will be omitted. Although the following description refers to a case where the disclosure is applied to a vehicle, the disclosure is also applicable to uses other than vehicles, such as flying objects including drones, ships, construction machinery, agricultural machinery, and the like.

### First Embodiment

### Vehicle

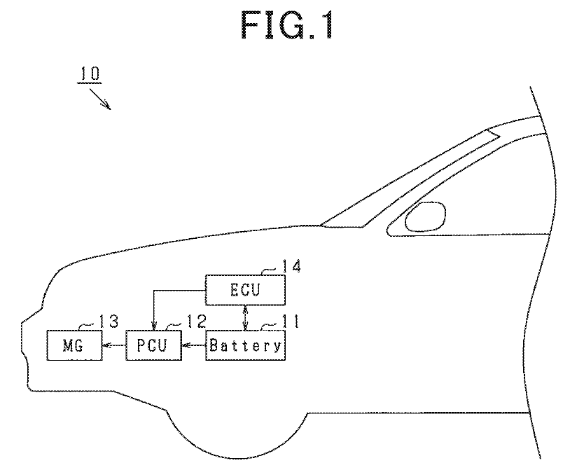

FIG. 1 is a diagram schematically showing the configuration of a vehicle 10. The vehicle 10 is an electrified vehicle such as an electric vehicle (EV), a hybrid vehicle (HV), or a plug-in hybrid vehicle (PHV). The vehicle 10 includes a battery pack 11 (indicated as ‘Battery’ in FIG. 1), a power control unit (hereinafter referred to as ‘PCU’) 12 serving as a power conversion device, a motor 13 (indicated as ‘MG’ in FIG. 1) serving as an electric load, and a vehicle ECU 14 (indicated as ‘ECU’ in FIG. 1). The PCU is an abbreviation for ‘Power Control Unit,’ MG is an abbreviation for ‘Motor Generator,’ and ECU is an abbreviation for ‘Electronic Control Unit.’

The battery pack 11 is mounted on the vehicle 10 as a driving power source for the vehicle 10. In FIG. 1, the battery pack 11 is arranged, for example, in a front compartment. Note that the battery pack 11 may be arranged in a rear compartment, under a seat, or under the floor.

The battery pack 11 includes a battery assembly 20 described later and is a chargeable and dischargeable DC voltage source. The battery pack 11 supplies electric power to electric loads of the vehicle 10. The battery pack 11 also converts electric power through the PCU 12 and supplies the electric power to the motor 13. Further, the battery pack 11 is charged through the PCU 12.

The PCU 12 performs bidirectional power conversion between the battery pack 11 and the motor 13 in accordance with a control signal from the vehicle ECU 14. For example, the PCU 12 is configured to include an inverter that converts a DC voltage from the battery pack 11 into an AC voltage to drive the motor 13, and a converter that boosts the DC voltage supplied to the inverter to a voltage higher than or equal to the output voltage of the battery pack 11.

The motor 13 is an AC rotary electric machine, and is, for example, a three-phase AC synchronous motor in which permanent magnets are embedded in a rotor. The motor 13 is driven by the PCU 12 to generate rotational driving force, and the driving force generated by the motor 13 is transmitted to the drive wheels. On the other hand, during braking of the vehicle 10, the motor 13 operates as a generator and performs regenerative power generation. The electric power generated by the motor 13 is supplied to the battery pack 11 through the PCU 12 and charged into the battery assembly 20.

The vehicle ECU 14 is configured to include a CPU, a ROM, a RAM, and input/output ports for receiving and outputting various signals. The CPU loads programs stored in the ROM into the RAM and executes the programs. The programs stored in the ROM describe processing performed by the vehicle ECU 14. As an example of major processing performed by the vehicle ECU 14, the vehicle ECU 14 receives information such as the voltage, current, SOC (State Of Charge), and SOH (State Of Health) of the battery assembly 20 from the battery pack 11, and controls the PCU 12 to instructs a driving of the motor 13 and charging and discharging of the battery pack 11.

### Battery Pack

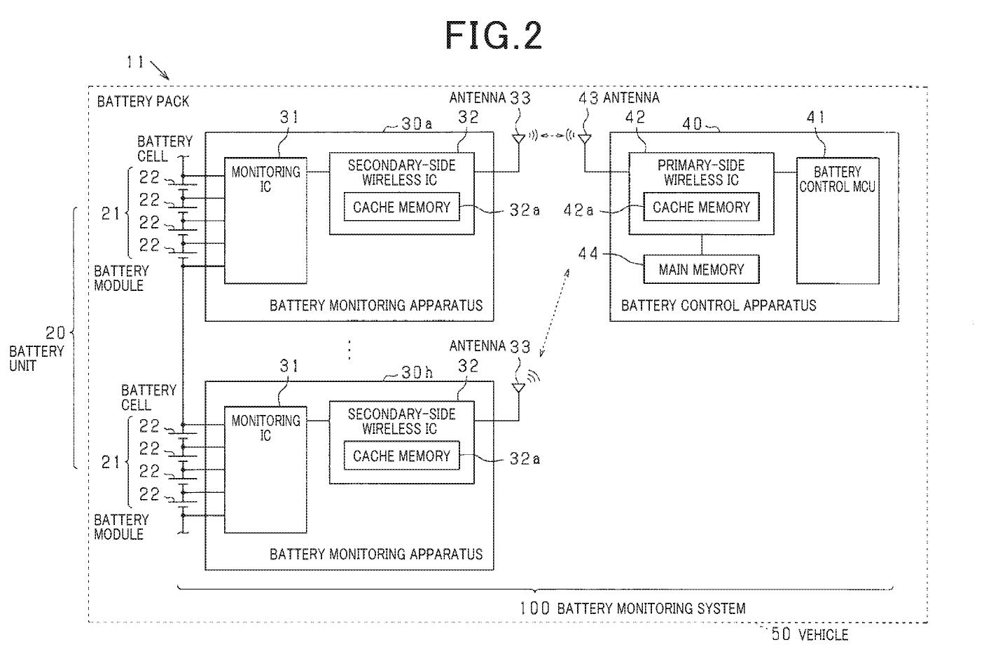

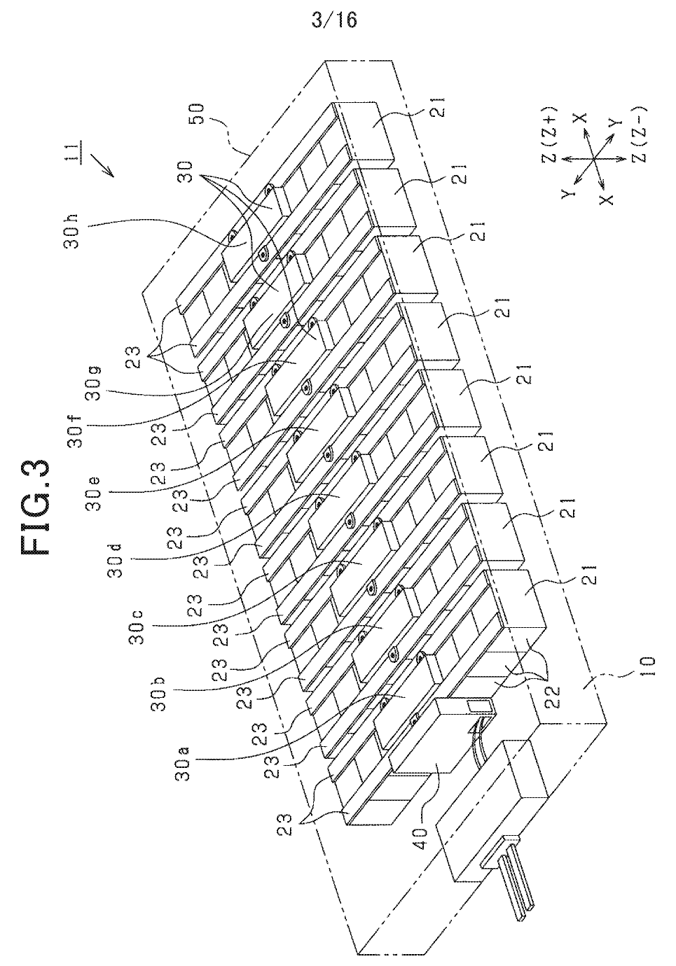

The battery pack 11 will be described in detail. FIG. 2 is a block diagram showing the configuration of the battery pack 11, and FIG. 3 is a perspective view showing the overall configuration of the battery pack 11. The battery pack 11 includes a battery assembly 20, a battery monitoring system 100, and a housing 50 (shown by a dashed line) that accommodates them. The battery monitoring system 100 is a system that monitors and manages the battery assembly 20 using wireless communication. The battery monitoring system 100 includes a plurality of battery monitoring apparatuses 30a to 30h and a battery control apparatus 40, and wireless communication is performed therebetween. In this wireless communication, frequency bands used for short-range communication, such as a 2.4 GHz band or a 5 GHz band, are used. Hereinafter, the battery monitoring apparatuses 30a to 30h may be referred to as a battery monitoring apparatus 30. Each of the battery monitoring apparatuses 30 and the battery control apparatus 40 corresponds to a wireless apparatus.

According to the present embodiment, the battery assembly 20, the battery monitoring apparatuses 30, and the battery control apparatus 40 are accommodated inside the housing 50 (battery accommodating space), but they may alternatively be arranged outside the housing 50. Further, the battery assembly 20 and the battery monitoring system 100 may be directly mounted in a battery accommodating space provided in the vehicle body frame or the like without providing the housing 50. In other words, the vehicle body frame may be used instead of the housing 50.

### Battery Assembly

The battery assembly 20 includes a plurality of battery blocks 21 (also referred to as battery stacks or battery modules). The battery assembly 20 is configured by connecting the plurality of battery blocks 21 in series and/or in parallel. Each battery block 21 includes a plurality of battery cells 22. Each battery cell 22 is constituted of, for example, a lithium-ion secondary battery or a nickel-metal hydride secondary battery. The lithium-ion secondary battery is a secondary battery that uses lithium as a charge carrier. In addition to a general lithium-ion secondary battery with a liquid electrolyte, it may also include a so-called all-solid-state battery that uses a solid electrolyte. Each battery block 21 is configured by connecting the plurality of battery cells 22 in series and/or in parallel. The battery block 21 may be optionally provided. The battery assembly 20 may also be configured simply by connecting the plurality of battery cells 22 in series and/or in parallel. According to the present embodiment, the battery assembly 20, the battery block 21, or the battery cell 22 corresponds to a battery unit.

### Battery Monitoring Apparatus

The battery monitoring apparatus 30 will be described. The configurations of the respective battery monitoring apparatuses 30 are common to each other. The battery monitoring apparatus 30 is also called as a Satellite Battery Module (SBM) and is provided for each battery block 21, that is, for each of the plurality of battery cells 22. As shown in FIG. 2, each battery monitoring apparatus 30 includes a monitoring IC 31, a secondary-side wireless IC 32, a secondary-side wireless antenna 33, and the like. The secondary-side wireless IC 32 is connected to the monitoring IC 31 via a wired connection. The secondary-side wireless IC 32 is also connected to the secondary-side wireless antenna 33 via a wired connection.

The monitoring IC 31, also called a cell monitoring circuit, acquires (senses) battery information of each battery cell 22 constituting the battery block 21 via physical quantity detection sensors (not shown). The physical quantity detection sensors include, for example, a voltage sensor, a temperature sensor, and a current sensor. The battery information includes, for example, voltage information, temperature information, current information, and the like for each battery cell 22. The target of monitoring by the battery monitoring apparatus 30 may be the battery block 21, the entire battery assembly 20, or may be arbitrarily changed.

When the monitoring IC 31 receives data requiring acquisition and transmission of the battery information (control data as control information), the monitoring IC 31 acquires the battery information and transmits monitoring data (control results) that includes at least the battery information. The monitoring IC 31 may perform a fault diagnosis (self-diagnosis) on the circuit portion of the battery monitoring apparatus 30, including itself, and may transmit the diagnosis results together with the acquired battery information in the monitoring data.

The secondary-side wireless IC 32 includes an RF circuit (not shown), a microprocessor, a front-end circuit, and the like for wirelessly transmitting and receiving data. The secondary-side wireless IC 32 has a transmission function that modulates data and oscillates at an RF signal frequency. In addition, the secondary-side wireless IC 32 has a reception function that demodulates received data. RF is an abbreviation for ‘radio frequency’.

The secondary-side wireless IC 32 modulates the monitoring data, including battery information received from the monitoring IC 31, and transmits the modulated monitoring data to the battery control apparatus 40 via the secondary-side wireless antenna 33. At this time, the secondary-side wireless IC 32 appends data necessary for wireless communication, such as communication control information, to the monitoring data including the battery information before transmission. Data necessary for wireless communication includes, for example, an identification number (ID) and an error detection code. Further, the secondary-side wireless IC 32 has functions such as determining the data size, communication format, and schedule of communication between the battery monitoring apparatus 30 and the battery control apparatus 40, as well as detecting errors.

Further, the secondary-side wireless IC 32 receives data wirelessly transmitted from the battery control apparatus 40 via the secondary-side wireless antenna 33 and demodulates the received data. For example, when the secondary-side wireless IC 32 receives control data including a request to acquire and transmit battery information, the secondary-side wireless IC 32 transmits (forwards) the request to the monitoring IC 31 via a wired connection. Then, in response to the request, when the secondary-side wireless IC 32 receives monitoring data including battery information from the monitoring IC 31, the secondary-side wireless IC 32 modulates the monitoring data and wirelessly transmits the modulated monitoring data to the battery control apparatus 40 via the secondary-side wireless antenna 33.

The secondary-side wireless antenna 33 converts RF signals, which are electrical signals, into radio waves and radiates them into space. The secondary-side wireless antenna 33 also receives radio waves propagating through space and converts them into electrical signals.

The secondary-side wireless IC 32 has a cache memory 32a capable of temporarily storing various types of data. The cache memory 32a stores data and instructions that are frequently accessed when transmitting and receiving data or when executing programs. The various types of data include, for example, data requiring acquisition and transmission of battery information, data necessary for wireless communication, and monitoring data including battery information. Normally, the contents stored in the cache memory 32a are erased when the battery monitoring apparatus 30 is in a stopped state (including a sleep state).

### Battery Control Apparatus

The battery control apparatus 40 is also referred to as a battery ECU or a BMU (Battery Management Unit). The battery control apparatus 40 is configured to be capable of wirelessly communicating with each of the battery monitoring apparatuses 30.

More specifically, as shown in FIG. 2, the battery control apparatus 40 includes a battery control MCU 41, a primary-side wireless IC 42, a primary-side wireless antenna 43, a main memory 44, and the like. The primary-side wireless IC 42 is connected to the battery control MCU 41 via a wired connection. The primary-side wireless IC 42 is also connected to the primary-side wireless antenna 43 via a wired connection. The main memory 44 is connected at least to the primary-side wireless IC 42 via a wired connection.

The battery control MCU 41 is constituted by a microprocessor unit (MCU) including a CPU, a ROM, a RAM, an input/output interface, and the like. The CPU of the battery control MCU 41 loads programs stored in the ROM into the RAM and executes the programs. The programs stored in the ROM include processing related to battery control.

As an example of major processing, the battery control MCU 41 transmits control data requiring acquisition and transmission of battery information to the battery monitoring apparatuses 30. The battery control MCU 41 also performs various types of processing related to monitoring of the battery assembly 20, the battery blocks 21, and the battery cells 22 based on monitoring data including battery information received from the battery monitoring apparatuses 30. For example, the battery control MCU 41 may transmit monitoring results (monitoring data) to the vehicle ECU 14 as an upper-level ECU. At that time, the battery control MCU 41 may calculate SOC and/or SOH based on the battery information and transmit the battery information including the calculated SOC and SOH to the vehicle ECU 14. Further, the battery control MCU 41 controls a relay switch that switches between a conduction state and a conduction cutoff state between the battery assembly 20 and the PCU 12 and motor 13 based on the monitoring results and the like. The battery control MCU 41 may also transmit an equalization signal for equalizing the voltages of the respective battery cells 22. According to the present embodiment, the vehicle ECU 14 issues instructions to the PCU 12 to control charging and discharging of the battery assembly 20. However, the battery control MCU 41 may alternatively be configured to perform such control. As described above, the battery control MCU 41 monitors and manages the battery assembly 20, the battery blocks 21, and the battery cells 22.

The primary-side wireless IC 42, like the secondary-side wireless IC 32, includes an RF circuit (not shown), a microprocessor, a front-end circuit, and the like for wirelessly transmitting and receiving data. The primary-side wireless IC 42, like the secondary-side wireless IC 32, has transmission and reception functions.

The primary-side wireless IC 42 demodulates the monitoring data including the battery information received via the primary-side wireless antenna 43, and transmits the demodulated data to the battery control MCU 41. The primary-side wireless IC 42 also modulates the control data received from the battery control MCU 41, after adding data necessary for wireless communication such as communication control information, and transmits the resulting data to the battery monitoring apparatus 30 via the primary-side wireless antenna 43. The data necessary for wireless communication includes, for example, an identification number (ID) and an error detection code. Furthermore, the primary-side wireless IC 42 has functions for determining the data size, communication format, schedule, and the like for communication between the battery monitoring apparatus 30 and the battery control device 40, as well as a function for detecting errors.

The primary-side wireless antenna 43 has the same configuration and functions as the secondary-side wireless antenna 33. That is, the primary-side wireless antenna 43 converts an RF signal, which is an electrical signal, into radio waves and radiates the converted signal into space. The primary-side wireless antenna 43 also receives radio waves propagating through space and converts them into electrical signals.

The primary-side wireless IC 42, like the secondary-side wireless IC 32, is provided with a cache memory 42a capable of temporarily storing data. Similarly to the cache memory 32a, the contents stored in the cache memory 42a are normally erased when the battery control apparatus 40 is in a stopped state (including a sleep state).

The battery control apparatus 40 includes a main memory 44 serving as a main storage device configured by, for example, DRAM. The main memory 44 may be shared with a storage device (such as a ROM) of the battery control MCU 41 in which a wireless communication program and the like are stored, or may be provided separately. Unlike the cache memories 32a and 42a, the main memory 44 is configured so that its stored contents are not erased even when the battery control apparatus 40 is in a stopped state (including a sleep state). The main memory 44 stores various programs, various types of history information (such as history relating to battery information), and various types of control information (such as an ID and other information relating to communication control).

### Housing

The housing 50 is formed of a conductive material such as metal. In the present embodiment, the housing 50 is formed in a metallic box shape and has a substantially rectangular parallelepiped shape. Note that part or all of the housing 50 may be formed of a non-conductive material such as resin. The housing 50 accommodates the battery assembly 20, the battery monitoring apparatus 30, and the battery control apparatus 40.

Here, the arrangement of the battery assembly 20, the battery monitoring apparatus 30, and the battery control apparatus 40 will be briefly described with reference to FIG. 3. The bottom surface of the housing 50 serves as a mounting surface for the vehicle 10. As shown in FIG. 3, inside the substantially rectangular parallelepiped housing 50, a plurality of battery blocks 21 constituting the battery assembly 20 are arranged side by side in the longitudinal direction (the X direction in FIG. 3). In each battery block 21, the battery cells 22 constituting the battery block 21 are arranged so as to be stacked in the lateral direction (the Y direction in FIG. 3).

The battery monitoring apparatus 30 and the bus bars 23 are arranged on the upper surface of each battery block 21 (the surface on the Z+ direction side in FIG. 3) and are fixed by screws or the like. The battery control apparatus 40 is arranged at one end in the longitudinal direction (X direction). At that time, a circuit board or the like on which the battery control apparatus 40 is mounted is attached to a side surface of one of the battery blocks 21 (in this embodiment, the battery block 21 at the end in the X direction) so that the circuit board stands vertically. It is desirable that the primary-side wireless antenna 43 be arranged so as to protrude above the upper surface of the battery block 21. The arrangement of the battery assembly 20, the battery monitoring apparatus 30, and the battery control apparatus 40 shown in FIG. 3 is merely an example, and may be appropriately modified.

### Wireless Communication

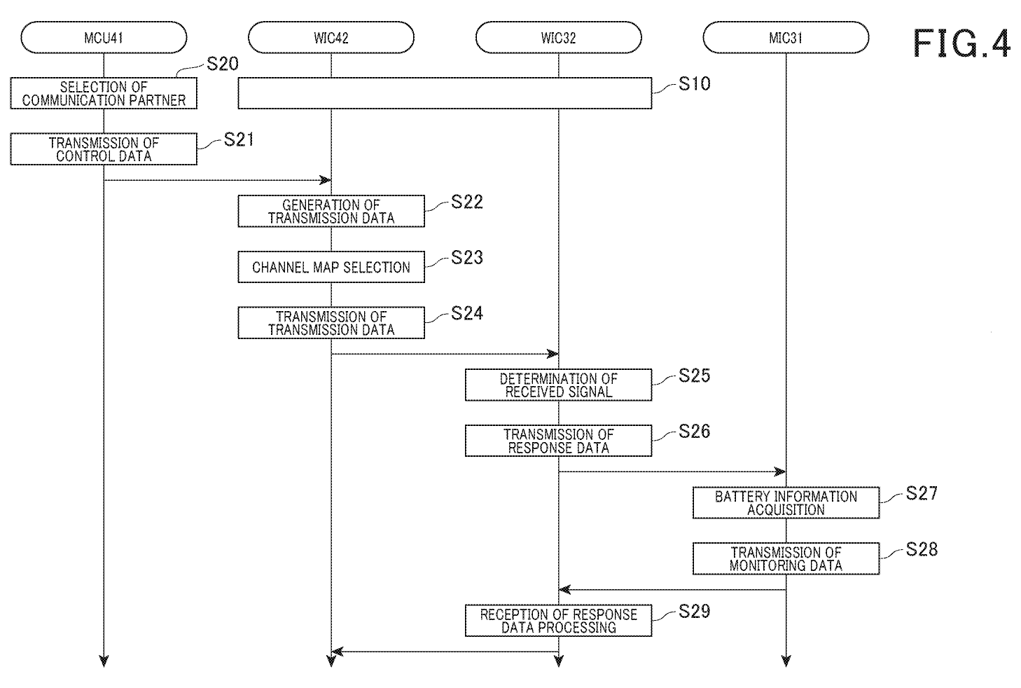

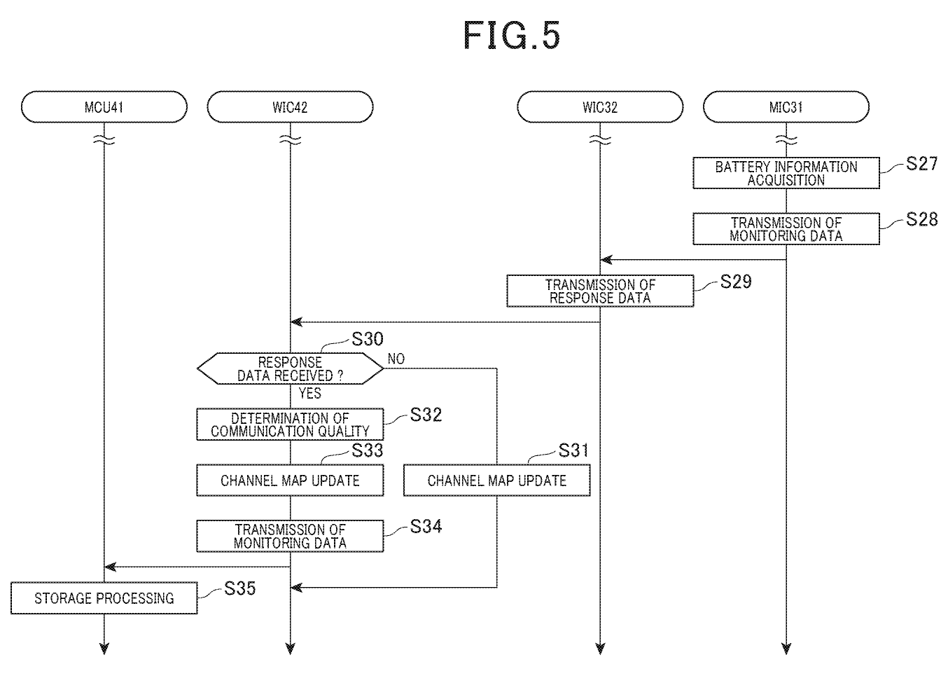

Next, wireless communication (a wireless communication method) between the battery monitoring apparatus 30 and the battery control apparatus 40 will be described with reference to FIGS. 4 to 6. FIGS. 4 and 5 are diagrams illustrating an example of a communication sequence in data communication between the battery monitoring apparatus 30 and the battery control apparatus 40. This communication sequence is repeated at predetermined intervals after activating the battery monitoring system 100 until a stopped state is entered, or is performed according to a predetermined communication schedule. Each process is executed when the battery monitoring apparatus 30 and the battery control apparatus 40 execute wireless communication programs stored in their respective storage devices (such as ROM).

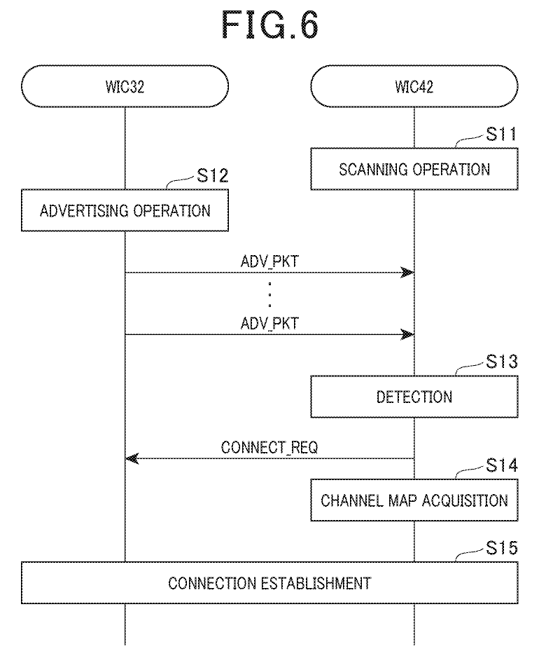

FIGS. 4 to 6 illustrate wireless communication between a single battery monitoring apparatus 30 and the battery control apparatus 40. The battery monitoring apparatus 30 that serves as the communication partner is determined according to a communication schedule or the like. In FIGS. 4 to 6, the monitoring IC 31 is indicated as MIC31, the secondary-side wireless IC 32 as WIC32, the battery control MCU 41 as MCU41, and the primary-side wireless IC 42 as WIC42. FIG. 6 illustrates an example of the connection process (Step S10) shown in FIG. 4.

As shown in FIG. 4, after the activation, the secondary-side wireless IC 32 of the battery monitoring apparatus 30 and the primary-side wireless IC 42 of the battery control apparatus 40 execute a connection process to establish a connection (Step S10).

This connection process is, for example, executed at the activation (start) of the battery monitoring system 100. ‘Activation’ refers to the time when the operating power supply is applied, for example. It may also occur upon input of an activation signal such as an IG signal output when the ignition switch is turned on. For example, when the user operates the ignition switch from OFF to ON, activation occurs. Further, when a predetermined condition is satisfied, the battery monitoring apparatus 30 and the battery control apparatus 40 transition to a sleep state (standby mode), but even in the sleep state, they intermittently activate. That is, they may spontaneously activate for operations such as voltage equalization of the battery cells 22 or voltage monitoring. The connection process may also be executed during such activation.

Then, at activation, the connection process is executed between the battery control apparatus 40 and all the battery monitoring apparatuses 30 as objects for wireless communication with the battery control apparatus 40.

Here, with reference to FIG. 6, the connection process of Step S10 will be described. As shown in FIG. 6, the primary-side wireless IC 42 of the battery control apparatus 40 performs a scan operation (secondary detection operation) (Step S11), and the secondary-side wireless IC 32 performs an advertise operation (connection information transmission operation) (Step S12). The activation of the scan operation may occur before the activation of the advertise operation, or at approximately the same timing, or even after the activation of the advertise operation.

The advertise operation refers to the operation in which the secondary-side wireless IC 32 transmits an advertisement packet (ADV_PKT) via broadcast communication to notify the primary-side wireless IC 42 of the battery control apparatus 40 of its presence. The advertisement packet corresponds to a communication unit, and the advertisement packet includes ID information (identification numbers) of both the secondary itself (the battery monitoring apparatus 30) and the battery control apparatus 40.

In this advertise operation, among a plurality of communication channels, communication channels for connection establishment (for advertising) are used.

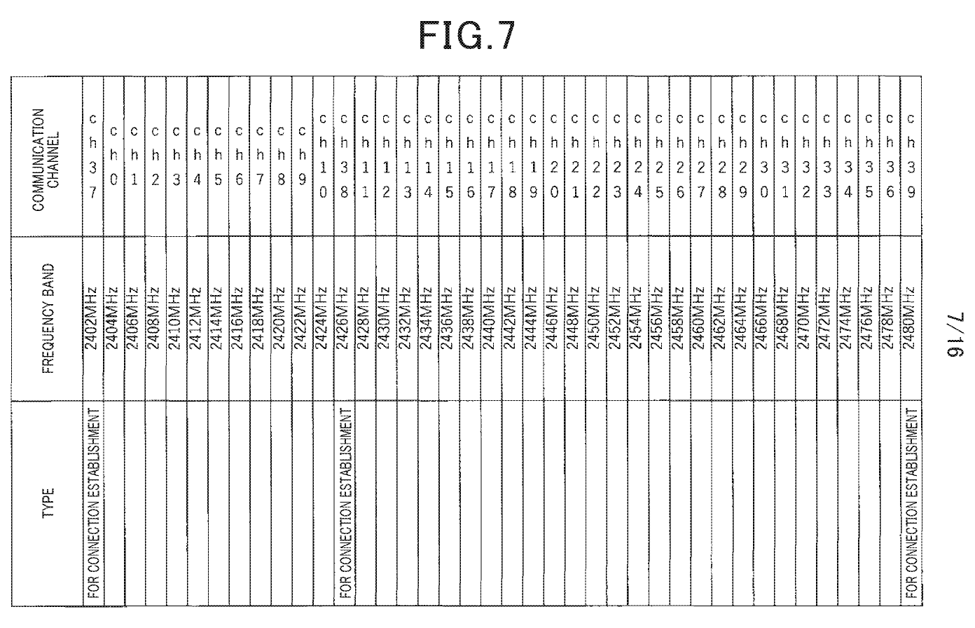

A communication channel refers to a frequency band used for short-range communication such as a frequency band in which the 2.4 GHz band is divided into predetermined bandwidths (for example, 2 MHz). In the present embodiment, as shown in FIG. 7, the band is divided into 40 channels from 0ch to 39ch. Among these 40 channels, predetermined communication channels (for example, 37 ch to 39 ch) are used for connection establishment. On the other hand, channels other than those for connection establishment (for example, 0ch to 36ch) among the plurality of communication channels are used as communication channels for data transmission, which will be described later.

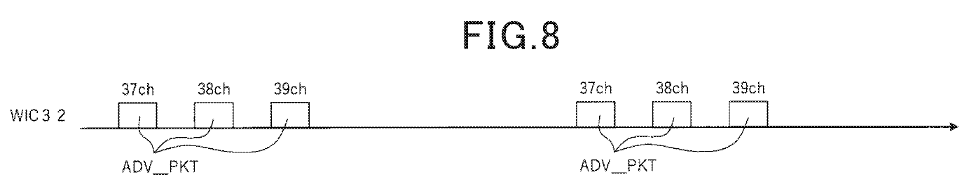

In the advertise operation, as shown in FIG. 8, advertisement packets are transmitted at predetermined intervals using a plurality (three in the present embodiment) of communication channels for connection establishment. Accordingly, even if a communication failure occurs on one of the connection-establishment communication channels, communication can be performed on another connection-establishment communication channel. For this reason, the three connection-establishment communication channels are set as far apart in frequency as possible so as to prevent mutual interference (see FIG. 7). It is also desirable that the communication channels for connection establishment be set so as not to overlap with frequency bands used by other devices or the like.

Returning to the description of the connection process, as shown in FIG. 6, when the primary-side wireless IC 42 of the battery control apparatus 40 detects an advertisement packet, that is, the secondary-side wireless IC 32 through the scan operation, a connection request signal (CONNECT_REQ) is transmitted to the detected secondary-side wireless IC 32 (Step S13).

At the same time as transmitting the connection request signal, the primary-side wireless IC 42 reads out and acquires a channel map stored in the main memory 44 (Step S14). The process of Step S14 and the channel map will be described later.

When the secondary-side wireless IC 32 receives the connection request signal, a connection, that is, a wireless communication link is established between one battery monitoring apparatus 30 and the battery control apparatus 40 (Step S15). Once the connection is established, the secondary-side wireless IC 32 of the battery monitoring apparatus 30 stops transmitting advertisement packets. The secondary-side wireless IC 32 periodically transmits advertisement packets until the connection is established.

When the connection is disconnected (i.e., the connected state is terminated) even though the battery monitoring apparatus 30 and the battery control apparatus 40 are not transitioning to the stopped state of the battery monitoring system 100 (including transition to the sleep state), the connection process (Step S10) is executed again. In other words, reconnection is performed. The battery control apparatus 40 performs reconnection (establishment of the connection) with the battery monitoring apparatus 30 whose connection has been disconnected, while continuing data communication with the remaining battery monitoring apparatuses 30 for which connections are still established. For example, if the connection is disconnected due to deterioration of the communication environment or the like, reconnection is performed.

Once the wireless communication connection is established, the connection process is thereafter skipped and the subsequent processing is performed, in principle, unless the connection is disconnected. That is, once the connection is established at Step S10, the battery control apparatus 40 periodically performs data communication (the processing of Steps S20 to S35) with the battery monitoring apparatus 30 unless a disconnection process (described later) for disconnecting the connection is executed in order to terminate the battery monitoring system 100.

The latter processes from Step S20 will be described in detail. As shown in FIG. 4, after the connection process is performed and the connection is established, the battery control MCU 41 of the battery control apparatus 40 selects a battery monitoring apparatus 30 to serve as the communication partner (Step S20). The battery monitoring apparatus 30 to serve as the communication partner is selected from among the battery monitoring apparatuses 30 for which connections have been established. In the present embodiment, the communication partner is selected in a pre-scheduled order. However, the selection method may be arbitrarily changed. Further, although the selection of the communication partner is performed by the battery control MCU 41, the primary-side wireless IC 42 may perform the selection process.

Next, the battery control MCU 41 of the battery control apparatus 40 transmits control data (control information), including a request to acquire monitoring data containing the battery information and a transmission request, to the battery monitoring apparatus 30 serving as the communication partner (Step S21).

When receiving the control data, the primary-side wireless IC 42 generates transmission data by adding data necessary for wireless communication, such as communication control information, to the control data (Step S22). In Step S22, the primary-side wireless IC 42 specifies the battery monitoring apparatus 30 serving as the communication partner and adds data necessary for wireless communication, such as communication control information, to the control data.

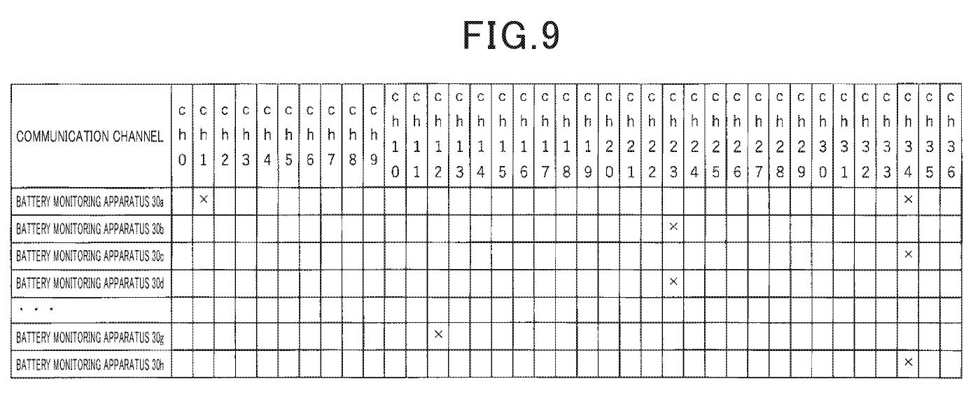

At the same time, the primary-side wireless IC 42 selects one communication channel for data transmission (for example, 0ch to 36ch) (Step S23). At this time, as shown in FIG. 9, the primary-side wireless IC 42 refers to a channel map in which each communication channel is set as either usable (selectable; the same applies hereinafter) or unusable (not selectable; the same applies hereinafter) as the status of each communication channel. The primary-side wireless IC 42 then selects a communication channel from among the usable communication channels for data transmission. The channel map is provided for each communication partner (secondary-side wireless IC 32), that is, for each of the battery monitoring apparatuses 30a to 30h. In FIG. 9, usable channels are indicated by blank spaces, and unusable channels are indicated by ‘x’.

The primary-side wireless IC 42 then wirelessly transmits the transmission data to the secondary-side wireless IC 32 via the primary-side wireless antenna 43 (Step S24). At this time, the primary-side wireless IC 42 performs the wireless transmission to the secondary-side wireless IC 32 using the selected communication channel for data transmission.

The secondary-side wireless IC 32 of the battery monitoring apparatus 30 selected as the transmission destination (communication partner) receives the transmission data via the secondary-side wireless antenna 33, and then determines whether the communication quality of the communication channel used for transmitting the transmission data was satisfactory (Step S25).

In Step S25, the secondary-side wireless IC 32 may, for example, determine that the communication quality is poor (not satisfactory) if the received signal strength (RSSI: Received Signal Strength Indicator) is below a predetermined threshold. Further, the secondary-side wireless IC 32 may determine the communication quality using a CRC (Cyclic Redundancy Check). Alternatively, the secondary-side wireless IC 32 may determine the communication quality based on whether the packet error rate is below a predetermined error rate. The secondary-side wireless IC 32 may also determine the communication quality based on the communication time from when the primary-side wireless IC 42 transmits to when the secondary-side wireless IC 32 receives. When the transmission data is divided and sent in packets, the secondary-side wireless IC 32 may determine the communication quality based on the variation in intervals between the arrival of one packet and the next. Additionally, the secondary-side wireless IC 32 may determine the communication quality based on the SNR (Signal to Noise Ratio). Other known methods may also be employed, or any combination of these methods may be used, and the communication quality may be determined based on the results of such evaluations.

After determining the communication quality, the secondary-side wireless IC 32 transmits the control data included in the received transmission data to the monitoring IC 31 (Step S26). When receiving the control data, the monitoring IC 31 acquires the battery information (sensing) in accordance with the control data (Step S27). In addition, the monitoring IC 31 may also perform a fault diagnosis for the circuit.

Next, the monitoring IC 31 transmits monitoring data including battery information, to the secondary-side wireless IC 32 in accordance with the control data (Step S28). At this time, the monitoring data may also include diagnostic results along with the battery information.

When receiving the monitoring data from the monitoring IC 31, the secondary-side wireless IC 32 generates transmission data including the monitoring data, that is, response data, and wirelessly transmits (responds) to the primary-side wireless IC 42 via the secondary-side wireless antenna 33 (Step S29). At this time, similarly to the process executed by the primary-side wireless IC 42 in Step S22, data necessary for wireless communication, such as communication control information, is added to the response data. In addition, communication quality data (the processing result of Step S25) is also added to the response data. Further, the secondary-side wireless IC 32 selects the same communication channel as that used when receiving the transmission data transmitted by the primary-side wireless IC 42, and wirelessly transmits to the primary-side wireless IC 42 using that communication channel. That is, the secondary-side wireless IC 32 performs transmission using the communication channel for data transmission selected in Step S23. Accordingly, the communication channel for data transmission corresponds to a communication channel for exchanging battery information used to send and receive battery information.

When it is determined in Step S25 that the communication quality is poor, the processes of Steps S26 to S29 are nevertheless executed as long as the control data included in the transmission data can be read. On the other hand, if the control data cannot be read, the process is terminated without executing the processes of Steps S26 to S29. Further, if the transmission data cannot be received, the process is also terminated without executing the processes of Steps S26 to S29.

As shown in FIG. 5, after transmitting the transmission data in step S24, the primary-side wireless IC 42 determines whether response data has been returned from the secondary-side wireless IC 32, which is the communication partner (step S30). Specifically, after transmitting the transmission data in step S24, the primary-side wireless IC 42 determines whether response data has been received within a predetermined period of time.

If the result of this determination is negative, that is, if the response data cannot be received normally and the communication quality can be determined to be poor, the primary-side wireless IC 42 updates the channel map so as to reflect this condition (step S31).

Here, the channel map and the updating of the channel map in step S31 will be described. The channel map is provided for each battery monitoring apparatus 30a to 30h serving as a communication partner, and is stored in the main memory 44 of the battery control apparatus 40. Specifically, the channel map is stored in the main memory 44 in association with the identification number (ID) of each battery monitoring apparatus 30a to 30h.

As described above, the channel map is read out in step S14 of the connection process and stored in the cache memory 42a of the primary-side wireless IC 42. At this time, the channel map is managed for each battery monitoring apparatus 30a to 30h in association with the identification number (ID) of each battery monitoring apparatus 30a to 30h (see FIG. 9). Then, in step S31, the channel map stored in the cache memory 42a is updated.

In step S31, the primary-side wireless IC 42 first specifies the channel map associated with the identification number of the battery monitoring apparatus 30 selected as the communication partner in step S20. Then, in that channel map, the primary-side wireless IC 42 changes the state (status) of the communication channel selected in step S23 to be ‘unusable’. For example, when the communication partner selected in step S20 is the battery monitoring apparatus 30a and the communication channel selected for data transmission in step S23 is communication channel ch1, the primary-side wireless IC 42 updates, in step S31, the channel map associated with the identification number of the battery monitoring apparatus 30a so that communication channel ch1 is set to be unusable. In FIG. 9, an unusable channel is indicated by ‘x’, and a usable channel is indicated by a blank. As a result, communication channel ch1 will not be selected in the next execution of step S23. Thereafter, the primary-side wireless IC 42 terminates the data communication in the current period.

If the determination result in step S30 is affirmative, that is, if response data has been returned, the primary-side wireless IC 42 determines whether the communication quality of the communication channel used for returning the response data was good (step S32). In step S32, the communication quality of the used communication channel is determined by performing process similar to that in step S25. At the same time, the communication quality is determined based on the communication quality determination result (the determination result in step S25) included in the response data. If the communication quality is determined to be poor based on either the transmission data or the response data, it is determined that the communication quality is poor. On the other hand, if neither indicates poor communication quality, it is determined that the communication quality is good.

Then, the primary-side wireless IC 42 updates the channel map in the same manner as in step S31 (step S33). That is, when it is determined in step S32 that the communication quality is poor, the primary-side wireless IC 42 first specifies the channel map associated with the identification number of the battery monitoring apparatus 30 selected as the communication partner in step S20. Then, in that channel map, the primary-side wireless IC 42 changes the state (status) of the communication channel selected in step S23 to be ‘unusable’. On the other hand, when it is determined in step S32 that the communication quality is good, the process of step S33 is terminated without updating the channel map.

After completion of step S33, the primary-side wireless IC 42 transmits the monitoring data included in the received response data to the battery control MCU 41 (step S34). The battery control MCU 41 executes predetermined process based on the monitoring data (step S35). Thereafter, the primary-side wireless IC 42 terminates the data communication in the current period. If the monitoring data cannot be read normally due to poor communication quality, the data communication is terminated without performing the process of step S34.

The battery control apparatus 40 periodically performs the above-described data communication with the battery monitoring apparatus 30 with which a connection has been established, until the battery monitoring system 100 transitions to a stopped state (including a sleep state).

As described above, the channel map stored in the cache memory 42a is continuously updated during operation of the battery monitoring system 100 based on the communication results, that is, the communication quality determination results. Accordingly, it becomes possible to select communication channels that are suitable for the environment in the radio wave propagation path.

Meanwhile, although the external environment of the battery pack 11 can frequently change as the vehicle 10 travels, the internal environment of the battery pack 11 does not change unless maintenance or the like is performed on the vehicle 10. In other words, the arrangement of the battery monitoring apparatus 30 and the battery control apparatus 40, the shape of the housing 50, and the arrangement of various components inside the housing 50 (such as wiring including the bus bars 23) are normally not changed even while the battery monitoring system 100 is stopped. Furthermore, since the housing 50 is made of a conductor, it is also less susceptible to external influences such as electromagnetic noise from outside the battery pack 11.

Therefore, it is considered that the propagation path of the radio waves used for wireless communication inside the battery pack 11 does not change significantly even while the battery monitoring system 100 is stopped. Nevertheless, when selecting communication channels at the activation of operation of the battery monitoring system 100 by referring to an initial (i.e., not yet updated) channel map, the number of communication errors tended to be high in the same way each time the system was activated. Accordingly, in the present embodiment, the system is configured as follows.

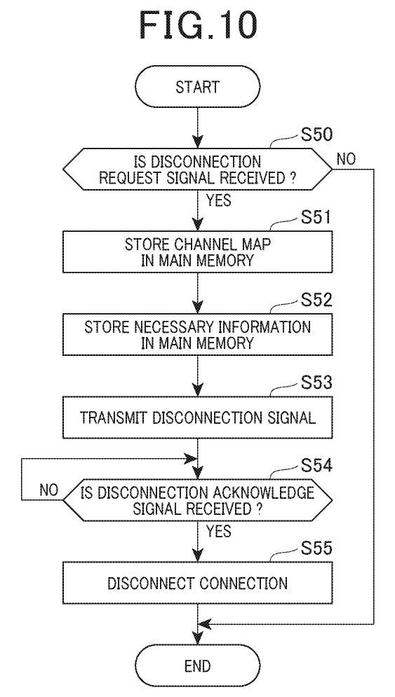

First, the processes at the time of termination of wireless communication will be described. When a connection has been established and data communication is ongoing, and the battery monitoring system 100 transitions to a stopped state (including a sleep state, hereinafter the same), the primary-side wireless IC 42 of the battery control apparatus 40 executes a disconnection process, as shown in FIG. 10, to terminate the wireless communication. The disconnection process is performed after the completion of the connection process, at any timing during data communication. For example, it may be executed at predetermined intervals, or at specific timings such as when a voltage drop occurs or when a disconnection request signal from an external source is received.

When the disconnection process is executed, the primary-side wireless IC 42 determines whether a disconnection request signal has been received (step S50). The disconnection request signal is, for example, received from an external device (such as the vehicle ECU 14) or the battery control MCU 41 when the battery monitoring system 100 transitions to a stopped state. Specifically, the disconnection request signal is received when the ignition switch is turned off. Additionally, for example, the disconnection request signal may be received when the vehicle 10 has come to a complete stop with the brake pedal depressed, a predetermined time has elapsed, and it is determined that the system is transitioning to a sleep state. Furthermore, the disconnection request signal may be received when the power supply voltage falls below a predetermined operating threshold, or when some abnormality or failure occurs, such as a communication error. If the determination result is negative, the disconnection process is terminated.

On the other hand, if the determination result in step S50 is affirmative, the primary-side wireless IC 42 stores the updated channel map in the cache memory 42a into the main memory 44 (step S51). At this time, the primary-side wireless IC 42 reads the updated channel map for each battery monitoring apparatus 30a to 30h and stores the updated channel map for each apparatus. In other words, the updated channel map is stored in the main memory 44 in association with the identification number (ID) of each battery monitoring apparatus 30a to 30h.

Furthermore, the primary-side wireless IC 42 reads from the cache memory 42a the information necessary for the next wireless communication and stores it into the main memory 44 (step S52). For example, if the cache memory 42a stores information necessary for wireless communication (such as the communication schedule or IDs) or the history of battery information, this information is stored into the main memory 44.

Next, the primary-side wireless IC 42 transmits a disconnection signal to each secondary-side wireless IC 32 (step S53). When receiving the disconnection signal, each secondary-side wireless IC 32 performs the processes necessary for disconnection on the secondary side and then transmits a disconnection acknowledgment signal to the primary-side wireless IC 42. After transmitting the disconnection acknowledgment signal, the secondary-side wireless IC 32 determines that the connection has been disconnected on the secondary side.

Meanwhile, the primary-side wireless IC 42 determines whether disconnection acknowledgment signals have been received from all of the secondary-side wireless ICs 32 (step S54). If the determination result in step S54 is affirmative, it is determined that the connection has been disconnected on the primary side (step S55). On the other hand, if the determination result in step S54 is negative, the primary-side wireless IC 42 waits for a predetermined period of time and then performs the process of step S54 again.

With reference to FIG. 6, based on the above description, the processes performed when the connection process is executed next after completion of the disconnection process will be described. The processes from steps S11 to S13 are the same as those described above, and therefore description thereof is omitted. As shown in FIG. 6, after transmitting the connection request signal (CONNECT_REQ) in step S13, the primary-side wireless IC 42 of the battery control apparatus 40 reads and acquires the channel map stored in the main memory 44 from the main memory 44 (step S14).

As described above, the main memory 44 stores an updated channel map for each secondary apparatus (that is, for each identification number of the battery monitoring apparatuses 30a-30h). Therefore, the primary-side wireless IC 42 stores, in the cache memory 42a, the channel map read from the main memory 44 for each secondary apparatus. In other words, the channel maps are stored in the cache memory 42a in association with the identification numbers of the respective battery monitoring apparatuses 30a-30h. Thereafter, as described above, a connection is established and the connection process is completed.

It should be noted that when an updated channel map is not stored in the main memory 44, the primary-side wireless IC 42 reads an initialized channel map that has been stored and saved in the main memory 44 from the beginning, and stores it in the cache memory 42a. Situations in which an updated channel map is not stored include, for example, when the first connection process is executed after manufacture of the battery pack 11, or when the channel map could not be properly saved during the disconnection process due to some circumstance. The initialized channel map may have any state for the respective communication channels. However, for example, a channel map in which all communication channels are available for use may be assumed.

Thereafter, when the process of step S23 is performed in data communication, the primary-side wireless IC 42 reads, from the channel maps stored in the cache memory 42a, the channel map associated with the identification number of the battery monitoring apparatus 30a-30h selected as the communication partner in step S20, and selects a communication channel with reference to the channel map.

It should be noted that the channel map stored in the cache memory 42a, once saved in step S14 of the connection process, continues to be updated in steps S31 and S33 based on the communication results (good or poor communication quality) unless the disconnection process is executed. On the other hand, the channel map stored in the main memory 44 is not updated unless step S51 of the disconnection process is executed.

In the first embodiment described above, steps S31 and S33 correspond to a channel map updating process, step S14 corresponds to a channel map acquisition process, step S51 corresponds to a channel map saving process, and step S23 corresponds to a communication channel selection process.

According to the above-described embodiment, the following effects and advantages can be obtained.

The primary-side wireless IC 42 acquires an updated channel map that reflects the communication results of the previous wireless communication (data communication) at the start of communication, and selects a communication channel with reference to the updated channel map. Therefore, at the start of data communication, by referring to a channel map that reflects the communication results of the previous data communication, the communication channel can be appropriately selected, reducing communication errors. In particular, in the battery pack 11, since the propagation paths of radio waves inside do not change, referring to the channel map that reflects the previous data communication results can effectively reduce communication errors.

The primary-side wireless IC 42 acquires the updated channel map stored in the main memory 44 from the start of the connection process until just before the start of data communication, specifically before the processing of step S20. By acquiring the updated channel map before the start of data communication, communication errors can be reduced at the start of data communication, and battery information can be reliably obtained from the beginning of communication.

In the connection process, when a connection request signal is transmitted and received, the communication partner is identified, and a connection is established. Therefore, by acquiring the channel map after the connection request signal has been transmitted and received (after step S13) but before the connection is established in step S15, that is, at the timing of step S14, it is possible to avoid a situation in which the acquired channel map goes unused and is wasted.

The updated channel map is stored in the main memory 44 from after the reception of a disconnection request signal until the connection is released during the disconnection process (up to step S55), specifically in step S51. In other words, the updated channel map is stored when data communication no longer occurs (i.e., when no new communication results are generated). This enables the channel map reflecting the latest communication results to be reliably stored.

The channel map is provided for each of the battery monitoring apparatuses 30a-30h, is updated for each of the battery monitoring apparatuses 30a-30h, is stored in the main memory 44 for each of the battery monitoring apparatuses 30a-30h during the disconnection process, and is read out for each of the battery monitoring apparatuses 30a-30h during the connection process. Accordingly, at the start of communication, an appropriate communication channel can be selected in accordance with the environment of each of the battery monitoring apparatuses 30a-30h.

The primary-side wireless IC 42 starts wireless communication when the battery monitoring system 100 is activated (including when operating power is supplied, when an activation signal is received, and when it wakes up spontaneously during a sleep state). When activating the wireless communication, the updated channel map is read from the main memory 44 during the connection process. Thereafter, the channel map is not read from the main memory 44 until the battery monitoring system 100 stops. This makes it possible to reduce the frequency of acquiring the channel map from the main memory 44.

The primary-side wireless IC 42, during wireless communication, terminates the wireless communication when the battery monitoring system 100 stops (including when the supply of operating power is stopped, when a stop signal is received, and when the system transitions to a sleep state). When terminating the wireless communication, the updated channel map is stored in the main memory 44 during the disconnection process. Thus, this makes it possible to reduce the frequency of storing the channel map in the main memory 44.

The primary-side wireless IC 42 stores the read updated channel map into the cache memory 42a at the activation of wireless communication. During the wireless communication, the primary-side wireless IC 42 updates the channel map based on communication results while referring to the channel map stored in the cache memory 42a. When terminating the wireless communication, the primary-side wireless IC 42 stores the updated channel map, which has been updated in the cache memory 42a, into the main memory 44. As a result, the channel map can be retained even when the system is terminated. Furthermore, the channel map is temporarily stored into the cache memory 42a, thereby reducing the frequency of reading the channel map from the main memory 44 and the frequency of storing the channel map. Thus, the processing rate during reference and update operations can be improved.

### MODIFICATIONS OF THE FIRST EMBODIMENT HEREINAFTER, MODIFICATIONS OF THE BATTERY MONITORING SYSTEM 100 ACCORDING TO THE FIRST EMBODIMENT WILL BE DESCRIBED.

In the first embodiment described above, a channel map is provided for each of the battery monitoring apparatuses 30a-30h. However, a single channel map which are shared by the battery monitoring apparatuses 30a-30h may instead be provided.

In the connection process (FIG. 6) of the first embodiment described above, the roles of the primary-side wireless IC 42 and the secondary-side wireless IC 32 may be exchanged. For example, although the primary-side wireless IC 42 transmits a connection request (Step S13) in the above-described embodiment, the secondary-side wireless IC 32 may instead transmit the connection request. In addition, the secondary-side wireless IC 32 may perform the scan operation (Step S11), and the primary-side wireless IC 42 may perform the advertise operation (Step S12).

In the channel map of the first embodiment described above, the status of a communication channel that has become unusable may be changed to usable at a predetermined timing. For example, after a predetermined period of time has elapsed, the status of the communication channel that has become unusable may be set to usable. Alternatively, for example, after a predetermined period of time has elapsed, data (such as test data) may be transmitted and received using the communication channel that has become unusable, the communication quality may be determined, and if the communication quality is good, the status may be changed to usable.

In the channel map of the first embodiment described above, when the communication quality is poor, the communication channel of which the communication quality was poor is set to unusable. However, the channel may instead be set to unusable only when the communication quality has been poor a predetermined number of times or continuously for a predetermined number of times.

In the first embodiment described above, a plurality of communication channels may be used in a single data transmission.

In Step S14 of the first embodiment described above, if the channel map has not been properly stored into the main memory 44, an initialized channel map may be acquired.

In the first embodiment described above, identification numbers are set for each of the battery monitoring apparatuses 30a-30h. However, they may instead be set for each secondary-side wireless IC 32. That is, when a single battery monitoring apparatus 30 has a plurality of secondary-side wireless ICs 32, it is necessary to manage them using identification numbers for each secondary-side wireless IC 32. Similarly, although identification numbers were set for the battery control apparatus 40, they may instead be set for the primary-side wireless IC 42.

In the first embodiment described above, the battery control apparatus 40 includes the main memory 44 as a storage device for storing the updated channel map. However, it may be provided outside the battery control apparatus 40. In addition, a storage device for storing the updated channel map may be provided in the battery monitoring apparatus 30.

In the first embodiment described above, the updated channel map is stored in the main memory 44 at the end of wireless communication, specifically during the disconnection process. However, the channel map in the main memory 44 may instead be overwritten and stored each time it is updated.

### Second Embodiment

A second embodiment, in which a part of the configuration of the battery monitoring system 100 of the first embodiment is modified, will be described.

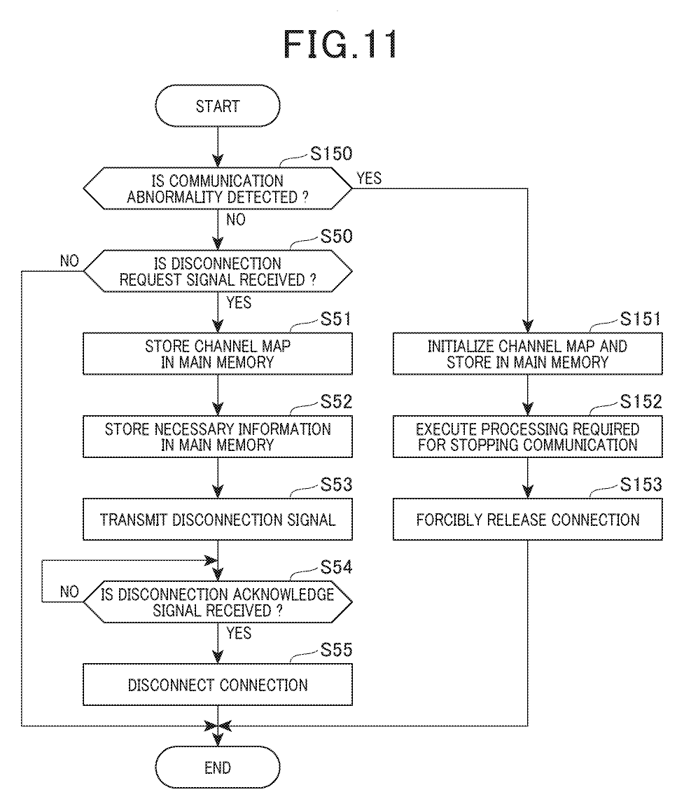

During the data communication, when a communication error occurs, the wireless communication may be difficult to continue and the connection may be forcibly disconnected. For example, a communication error may occur if the power supply to the primary-side wireless IC 42 or the secondary-side wireless IC 32 becomes unstable, or if communication is disturbed due to the influence of strong external electromagnetic noise. In such situations, if the channel map is updated based on the communication results, the number of communication channels set as unusable may increase. Therefore, in the disconnection process of the second embodiment, when the connection is disconnected due to a communication error, the updated channel map is not stored. The disconnection process of the second embodiment will be described below with reference to FIG. 11.

In the second embodiment, when the disconnection process is executed, the primary-side wireless IC 42 determines whether a communication error has occurred (Step S150). The method for determining a communication error may be any known method. For example, if data communication cannot be successfully performed multiple times (for instance, if the determination result in Step S30 is consecutively negative, or if the communication quality in Step S32 is consecutively poor), it is determined that a communication error has occurred. In addition, a communication error may be determined to have occurred when the power supply becomes unstable or when strong external electromagnetic noise is present.

If the determination result is negative, the primary-side wireless IC 42 executes the processes from Step S50 onward. Since the processes from Step S50 onward are the same as those of the first embodiment, a description thereof will be omitted. On the other hand, if the determination result in Step S150 is affirmative, the primary-side wireless IC 42 initializes the channel map and stores the initialized channel map into the main memory 44 without storing the updated channel map in the main memory 44 (Step S151). Next, the primary-side wireless IC 42 performs processes necessary to cutoff the communication and processes for notifying that a communication error has occurred (Step S152). The processes necessary to cutoff the communication includes, similarly to Step S52, processes such as reading information required for the next wireless communication from the cache memory 42a and storing it in the main memory 44. Then, the primary-side wireless IC 42 forcibly (unilaterally) disconnects the connection (Step S153), and terminates the process.

### Effects and advantages of the second embodiment will be described.

When a communication error occurs, it is highly likely that abnormalities also occur in the communication results. If the channel map is updated based on such communication results, there is a high possibility that the channel map will not be updated appropriately. Therefore, if communication is performed according to such a channel map, communication errors may instead occur, or it may become difficult to select a normal communication channel. Accordingly, when a communication error occurs, the updated channel map is not stored so that it will not be used in the next wireless communication.

Because the channel map referenced at the start of the previous communication is referenced again, a communication error may occur again, or the number of selectable communication channels may decrease. Therefore, in the second embodiment, when a communication error occurs, an initialized channel map is used in the next wireless communication. As a result, the possibility of such problems occurring can be reduced.

### Modifications of the Second Embodiment

Hereinafter, modifications of the battery monitoring system 100 according to the second embodiment will be described.

In the second embodiment described above, the channel map stored in the main memory 44 (i.e., the channel map to be read in the next connection process) is initialized. However, it does not necessarily have to be initialized. That is, it is sufficient simply not to overwrite the updated channel map in the main memory 44. As a result, it becomes possible to refer to the updated channel map that was updated during wireless communication performed prior to the wireless communication in which the communication error occurred.

In the second embodiment described above, the channel map stored in the main memory 44 (i.e., the channel map to be read in the next connection process) is initialized. However, it may instead simply not be stored. In that case, an initialized channel map may be read in the next connection process. That is, when the connection is disconnected due to a communication error, that fact may be stored, and if it is stored that the connection was disconnected due to a communication error, an initialized channel map may be read in the connection process.

### Third Embodiment

A third embodiment, in which a part of the configuration of the battery monitoring system 100 of the first embodiment is modified, will be described.

When the channel map is updated in an external environment with a large amount of noise, the communication quality tends to deteriorate, and even communication channels that would be usable in an external environment with less noise tend to be set to unusable, resulting in an increased number of unusable communication channels. Furthermore, if a channel map in which the number of usable communication channels is extremely small and there is little room for selection is referenced from the start of communication, it may become difficult to continue the wireless communication.

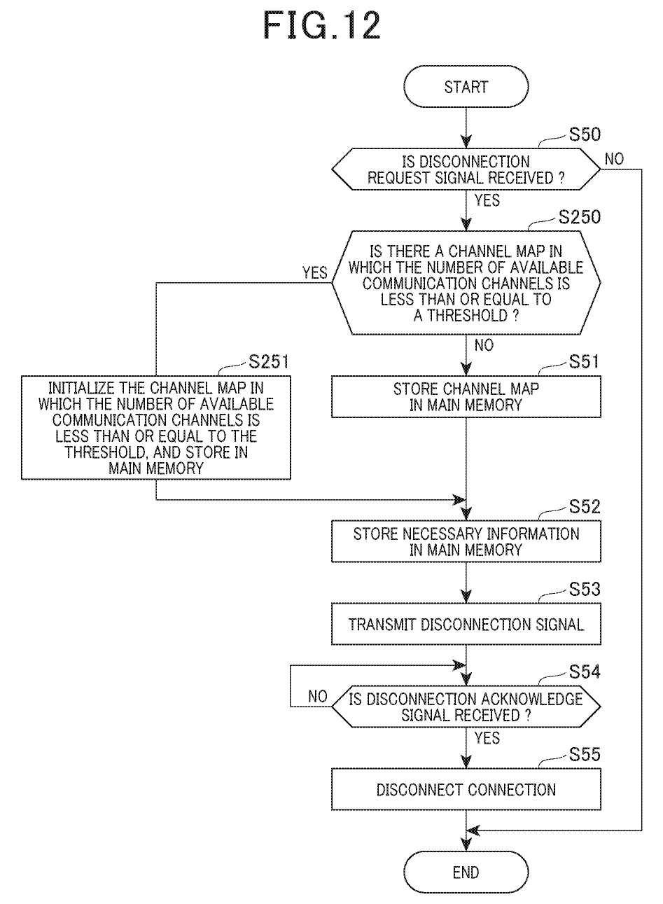

Therefore, in the disconnection process of the third embodiment, when the number of communication channels set as usable in the updated channel map becomes equal to or less than a predetermined threshold, the updated channel map is not stored. In other words, it is not carried over to the connection process in the next and subsequent communications. The disconnection process of the third embodiment will be described below with reference to FIG. 12.

In the third embodiment, when the disconnection process is executed, the primary-side wireless IC 42 determines whether a disconnection request signal has been input, as in the first embodiment (Step S50). If the result of this determination is affirmative, the primary-side wireless IC 42 determines whether there exists a channel map, among the channel maps stored in the cache memory 42a, in which the number of communication channels that are available for use is less than or equal to a threshold (Step S250). In Step S250, the determination is performed for each battery monitoring apparatus 30a to 30h, that is, for each channel map associated with an identification number.

If the result of this determination is affirmative, the primary-side wireless IC 42 initializes the channel map identified in Step S250 and stores the initialized channel map into the main memory 44, while storing channel maps other than the channel map identified in Step S250 in association with their respective identification numbers in the main memory 44 (Step S251). Then, the primary-side wireless IC 42 performs the processes from Step S52 onward, as in the first embodiment. If the result of the determination in Step S250 is negative, the primary-side wireless IC 42 proceeds to the process of Step S51.

The effects and advantages of the third embodiment will be described.

During the data communication process, if there exists a channel map in which the number of usable communication channels in the updated channel map is less than or equal to a predetermined threshold, the primary-side wireless IC 42 does not store the channel map into the main memory 44. Thus, it is possible to prevent a situation in which the number of usable communication channels becomes too small, leaving little room for selection and consequently making it impossible to select an appropriate communication channel.

When the channel map referenced during the previous communication is used, the number of usable communication channels may again become small. Therefore, in the third embodiment, when the number of usable communication channels becomes less than or equal to a predetermined threshold, the channel map of which the number of usable channels has fallen below the threshold is initialized, and the initialized channel map is used in the next wireless communication. As a result, the possibility of such a problem occurring can be reduced.

### Modifications of the Third Embodiment

Hereinafter, modifications of the battery monitoring system 100 according to the third embodiment will be described.

In the third embodiment, when the number of usable communication channels becomes less than or equal to a predetermined threshold, the channel map (the channel map to be read in the next connection process) is initialized. However, the channel map does not necessarily have to be initialized. In other words, it is sufficient not to overwrite the main memory 44 with the updated channel map. As a result, the updated channel map updated in the previous wireless communication can be used in subsequent wireless communications.

In the second embodiment, the channel map of which the number of usable communication channels has become less than or equal to a predetermined threshold is initialized. However, it is also sufficient simply not to save it. Then, in the next connection process, the initialized channel map may be read. In other words, at the start of the communication, if a channel map of which the number of usable communication channels is less than or equal to a predetermined threshold is read from the main memory 44, the channel map may be initialized during the connection process.

### Modifications of the Fourth Embodiment

A fourth embodiment, in which a part of the configuration of the battery monitoring system 100 of the first embodiment is modified, will be described.

The type (frequency) and the number of electromagnetic noise sources may vary depending on the external environment. In other words, the communication channels that provide good communication quality may differ depending on the external environment. Moreover, When the vehicle 10 is traveling, environmental conditions change rapidly, causing high-quality (or poor-quality) channels to switch frequently. Therefore, even if the updated channel map is read in the next wireless communication while the vehicle 10 is traveling, an updated channel map from a previous communication may have limited usefulness for the next wireless communication.

On the other hand, when the vehicle 10 is stopped, changes in the external environment are expected to be minimal, and the channel map is updated primarily based on the internal conditions of the battery pack 11. Therefore, by reading a channel map updated to reflect the relatively stable internal environment of the battery pack 11 in the subsequent wireless communications, it is expected that communication errors can be reduced. Accordingly, in the fourth embodiment, the system is configured as follows.

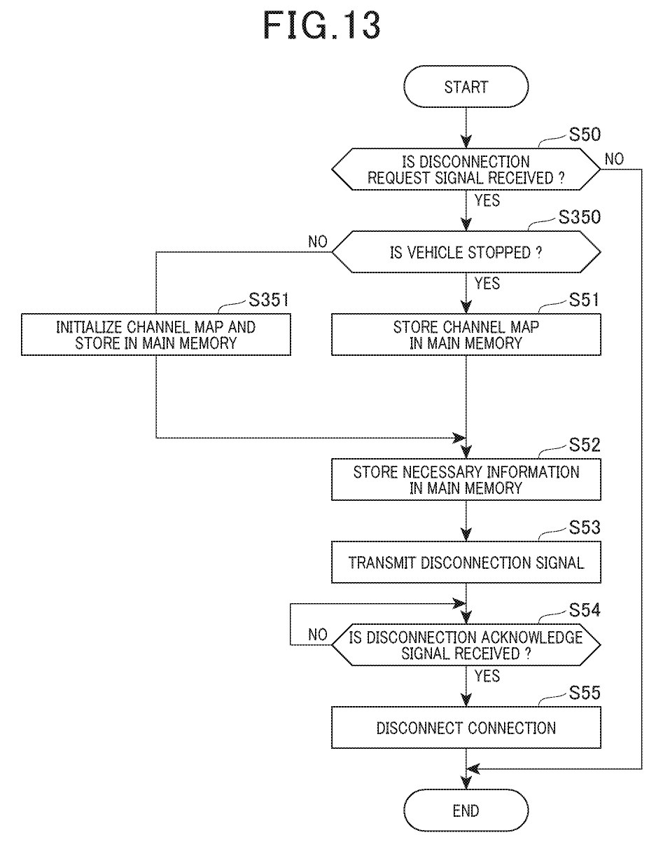

As shown in FIG. 13, in the fourth embodiment, when a disconnection process is executed, the primary-side wireless IC 42 determines, as in the first embodiment, whether a disconnection request has been received (Step S50). If the result of this determination is affirmative, the primary-side wireless IC 42 determines whether the vehicle 10 is in a stopped state during the period from the start of activation of the battery monitoring system 100 until the time when the disconnection request is received (Step S350). Specifically, this determination may be made by receiving, from an external apparatus such as the vehicle ECU 14, information indicating whether the vehicle 10 is stopped during the period from the start of the battery monitoring system 100 until the disconnection request is received, and determining based on that information. It may be determined whether the vehicle 10 is stopped using a known method, for example, based on the vehicle speed obtained from a vehicle speed sensor.

If the result of this determination is affirmative, the primary-side wireless IC 42 performs the processes from Step S51 onward. On the other hand, if the result of the determination in Step S350 is negative, the primary-side wireless IC 42 initializes the channel map and stores the initialized channel map into the main memory 44 without saving the updated channel map in the main memory 44 (Step S351). The primary-side wireless IC 42 then performs the processes from Step S52 onward.

Hereinafter, the effects and advantages of the fourth embodiment will be described.

The primary-side wireless IC 42 stores, in the main memory 44, only the channel map that has been updated while the vehicle 10 is stopped. Thus, a channel map reflecting the internal environment of the vehicle can be generated and stored without being affected by the external environment. Therefore, not only when the vehicle 10 is stopped, but also when the vehicle 10 is traveling and the external environment of the vehicle 10 changes, the channel map can remain effective to a certain extent.

### Modifications of Fourth Embodiment

Hereinafter, modifications of the battery monitoring system 100 according to the fourth embodiment will be described.

In the fourth embodiment described above, the determination as to whether the vehicle 10 is stopped may be performed by the battery control MCU 41 or the primary-side wireless IC 42 receiving vehicle speed information or the like.

In the fourth embodiment described above, when the result of the determination in Step S350 is negative, the channel map is initialized. However, it is also possible to simply skip the process of Step S51. That is, the channel map stored in the main memory 44 may be used in the next wireless communication without overwriting the channel map stored in the main memory 44.

In the fourth embodiment described above, only the channel map updated during a sleep state or when the ignition switch is off may be stored in the main memory 44 and carried over to subsequent wireless communications.

In the fourth embodiment described above, the communication quality of all communication channels may be determined while the vehicle 10 is stopped, and a channel map in which availability of each communication channel is set based on the determination results may be stored into the main memory 44.

### Fifth Embodiment

A fifth embodiment, in which part of the configuration of the battery monitoring system 100 according to the first embodiment described above is modified, will be described.

In the first embodiment, the channel map is referenced only for the primary-side wireless IC 42. In the fifth embodiment, however, the channel map is also referenced for the secondary-side wireless IC 32. The above configuration will be described in detail below.

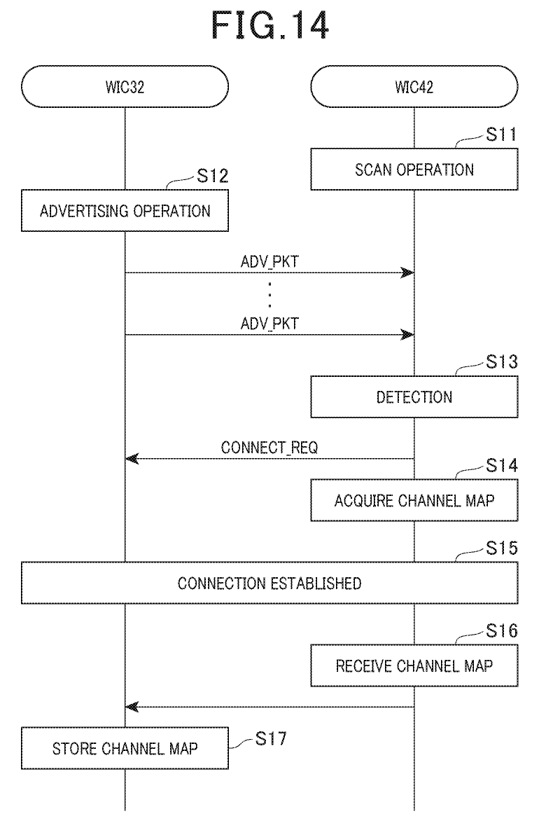

First, with reference to FIG. 14, the connection process in the fifth embodiment will be described. As in the first embodiment, Steps S11 to S15 of the connection process are executed, and a connection is established. After the connection is established, the primary-side wireless IC 42 distributes the updated channel map stored in the cache memory 42a in Step S14 to each of the battery monitoring apparatuses 30a to 30h based on the associated identification numbers (Step S16).

Upon receiving the channel map, the secondary-side wireless IC 32 of each of the battery monitoring apparatuses 30a to 30h stores the channel map in its cache memory 32a (Step S17). The connection process is then terminated.

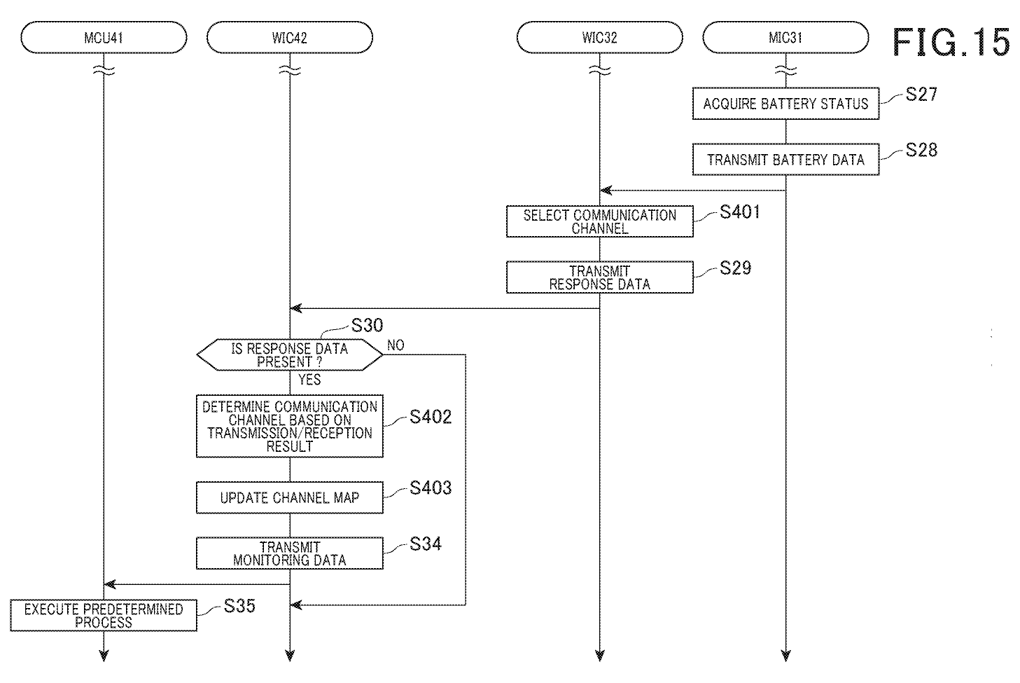

In the data communication according to the fifth embodiment, as shown in FIG. 15, when the secondary-side wireless IC 32 receives the monitoring data transmitted from the monitoring IC 31 in Step S28, the secondary-side wireless IC 32 refers to the channel map stored in the cache memory 32a and selects one communication channel for data transmission from among the communication channels for data transmission (for example, 0ch to 36ch) (Step S401). In Step S401, the communication channel is selected from among the usable communication channels that are available for use. The selected communication channel may be different from the communication channel selected by the primary-side wireless IC 42 in Step S23. Further, when it is determined in Step S25 that the communication quality is poor, it is preferable to select a communication channel different from the communication channel selected by the primary-side wireless IC 42 in Step S23.

The secondary-side wireless IC 32 then proceeds to Step S29. As in the first embodiment, the secondary-side wireless IC 32 generates response data and wirelessly transmits (responds with) the response data to the primary-side wireless IC 42 via the secondary-side wireless antenna 33 (Step S29). At this time, the response data is transmitted using the communication channel selected in Step S401.

Then, the primary-side wireless IC 42 performs the process of Step S30 as in the first embodiment. When the result of the determination in Step S30 is negative, the primary-side wireless IC 42, unlike in the first embodiment, terminates the process without updating the channel map. This is because the communication channel used for transmitting the transmission data may differ from the communication channel used for transmitting the response data, and it cannot be determined during use of which communication channel the data transmission was successfully performed.

On the other hand, when the result of the determination in Step S30 is affirmative, the primary-side wireless IC 42 determines the communication quality of the communication channel selected in Step S23 (the communication channel used at the time of transmission) and the communication quality of the communication channel used for returning the response data (the communication channel used at the time of response) (Step S402).

The communication quality of the communication channel selected in Step S23 is determined based on the determination result of the communication quality (the determination result of Step S25) included in the response data. On the other hand, the communication quality of the communication channel used for returning the response data is determined by performing a process similar to that of Step S25.

Next, the primary-side wireless IC 42 updates the channel map associated with the identification number of the battery monitoring apparatus 30, which is the communication partner selected in Step S20, based on the determination results in Step S402 (Step S403). Specifically, when it is determined in the process of Step S402 that the communication quality of the communication channel selected in Step S23 is poor, the primary-side wireless IC 42 changes the state (status) of the communication channel to unusable. Further, when it is determined in the process of Step S402 that the communication quality of the communication channel used for returning the response data is poor, the primary-side wireless IC 42 changes the state (status) of the communication channel to unusable. When the communication quality is good, the channel map is not updated.

When the channel map is updated, the primary-side wireless IC 42 transmits the updated channel map to the secondary-side wireless IC 32 of the battery monitoring apparatus corresponding to the identification number associated with the updated channel map among the battery monitoring apparatuses 30a to 30h. Although not shown in the drawings, when the secondary-side wireless IC 32 receives the updated channel map, the secondary-side wireless IC 32 overwrites and stores the channel map stored in its cache memory 32a.

Then, the primary-side wireless IC 42 performs the processes from Step S34 onward as in the first embodiment.

According to the fifth embodiment described above, the following effects and advantages are achieved.

The primary-side wireless IC 42 is configured to store the updated channel maps in the main memory 44. In the connection process (that is, at the activation of wireless communication), the primary-side wireless IC 42 reads the updated channel maps stored in the main memory 44 and transmits the read updated channel maps to the respective secondary-side wireless ICs 32. Thus, by managing the channel maps collectively by the primary-side wireless IC 42 in this manner, the number of main memories 44 and the required storage capacity can be reduced. In addition, failures such as inconsistencies in the contents of the updated channel maps between the primary-side wireless IC 42 and the secondary-side wireless ICs 32 can be avoided.

Then, in the activation of wireless communication, the secondary-side wireless IC 32 stores the channel map received from the primary-side wireless IC 42 into the cache memory 32a, and in the time of transmitting response data (that is, at the time of response), refers to the channel map stored in the cache memory 32a to select a communication channel. As a result, when the communication quality of the communication channel used at the time of transmission is poor, the response data can be returned using a different communication channel.

Further, in a single data communication, the communication quality of different communication channels can be obtained between the primary-side wireless IC 42 side and the secondary-side wireless IC 32 side, whereby the updating speed of the channel map can be improved.

### Modifications of Fifth Embodiment

Hereinafter, modifications of the battery monitoring system 100 according to the fifth embodiment will be described.

In the fifth embodiment described above, when the channel map is updated in Step S402, the updated channel map is transmitted to the secondary-side wireless IC 32 so that the channel map in the cache memory 32a in the secondary-side wireless IC 32 side is also updated. However, the timing of the update may be changed as appropriate. Further, the channel map in the cache memory 32a in the secondary-side wireless IC 32 side does not necessarily need to be updated.

In the fifth embodiment described above, when the result of the determination in Step S30 is negative (that is, when the response data cannot be received), the channel map is not updated. However, the channel map may be updated. In this case, the communication quality of the communication channel used at the time of transmission and the communication quality of the communication channel used at the time of response may both be regarded as poor, and the channels may be set to unusable.

In the fifth embodiment described above, the secondary-side wireless IC 32 of the battery monitoring apparatus 30 may update the channel map stored in the cache memory 32a based on the result of Step S25. In this case, the contents of the channel map stored in the cache memory 42a of the primary-side wireless IC 42 and the contents of the channel map stored in the cache memory 32a of the secondary-side wireless IC 32 may differ. Therefore, it is preferable that the contents be matched at some timing. When matching the contents, for example, if there exists a communication channel that is set to unusable in either channel map, the communication channel may be set to unusable in both channel maps. Alternatively, if there exists a communication channel that is set to usable in either channel map, the communication channel may be set to usable in both channel maps.

### Sixth Embodiment

Hereinafter, a sixth embodiment of the battery monitoring system 100, in which part of the configuration of the first embodiment is modified, will be described.

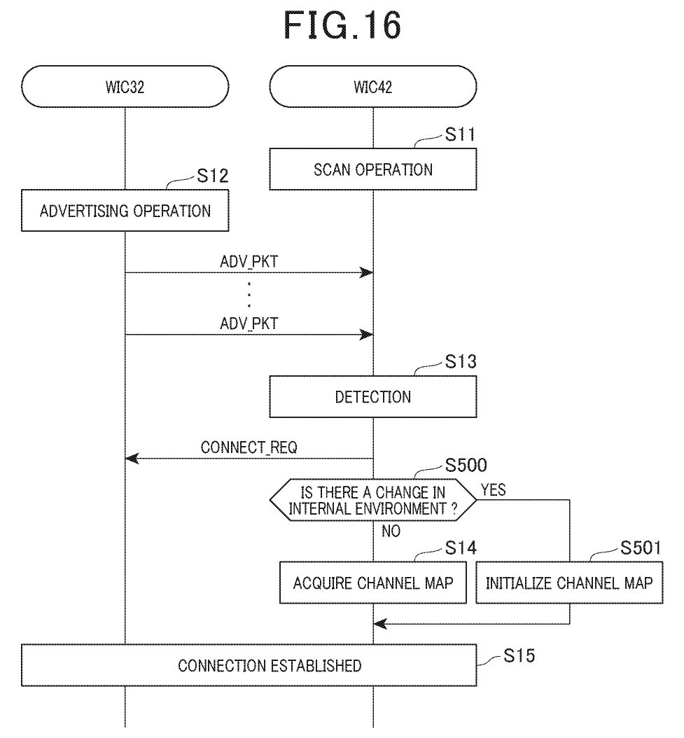

If the arrangement of the battery control apparatus 40 or the battery monitoring apparatus 30 is changed, or if the size, number, shape, or arrangement of the battery cells 22, the battery blocks 21, or the battery assembly 20 is changed, or if the shape of the housing 50 is changed, the propagation path of radio waves, including reflection angles and reflection positions, is highly likely to change. When the propagation path of the radio waves changes, the communication quality of each communication channel is also likely to change. Therefore, when the internal environment of the battery pack 11 has changed, the previously used channel map is highly likely to become unreliable as a reference. Accordingly, in the connection process according to the sixth embodiment, it is determined whether the internal environment of the battery pack 11 has changed, and based on this determination, a decision is made as to whether to acquire an updated channel map. The connection process according to the sixth embodiment will be described in detail below with reference to FIG. 16.

In the connection process according to the sixth embodiment, after transmitting a connection request signal (after step S13) and before reading a channel map from the main memory 44 (before step S14), the primary-side wireless IC 42 determines whether the internal environment of the battery pack 11 has changed (step S500). Specifically, when the number or arrangement of the secondary-side wireless ICs 32 serving as communication partners has been changed, or when any of the secondary-side wireless ICs 32 has been replaced with another secondary-side wireless IC 32, information indicating that the internal environment has been changed is stored into the main memory 44 or the like. Therefore, the primary-side wireless IC 42 reads from the main memory 44 or the like whether information indicating the presence or absence of such a change has been stored, and performs the determination of step S500. When the determination result is affirmative (i.e., when there is no change), the process of step S14 is executed in the same manner as in the first embodiment. When the determination result is negative (i.e., when there is a change), the primary-side wireless IC 42 initializes the channel map and stores the initialized channel map into the cache memory 42a (step S501). Thereafter, the primary-side wireless IC 42 proceeds to the process of step S15.

According to the sixth embodiment described above, the following effects and advantages are achieved.

When the internal environment of the battery pack 11 is changed and there is a high possibility that the previous channel map may no longer be reliable, the channel map is initialized. Accordingly, it is possible to prevent a communication channel that should have good communication quality in the current internal environment from being determined to be unusable. Further, it is also possible to prevent a communication channel that should have poor communication quality in the current internal environment from being determined to be usable.

### Modifications of Sixth Embodiment

Hereinafter, modifications of the battery monitoring system 100 according to the sixth embodiment will be described.

In the sixth embodiment described above, a list of identification numbers of the secondary-side wireless ICs 32 serving as communication partners may be stored (managed) into the main memory 44 or the like, and when the list is changed, the determination result of step S500 may be negative (i.e., it may be determined that a change has occurred).

In the sixth embodiment described above, a list of identification numbers of the secondary-side wireless ICs 32 serving as communication partners in the previous data communication may be stored (managed) in the main memory 44 or the like. When establishment of a connection is requested by a secondary-side wireless IC 32 having an identification number that is not stored in the main memory 44, it may be determined that a change has occurred.

In the sixth embodiment described above, when a change is made to a configuration related to the internal environment, such as the housing 50 or the battery assembly 20, information indicating that the internal environment has been changed may be stored into the main memory 44.

### Other Modifications

In each of the embodiments and modifications described above, wireless communication may be performed at a predetermined timing, and a channel map updated based on a communication result of the wireless communication may be stored as an initialized channel map. The predetermined timing is preferably, for example, a timing in an environment where no external noise is present, such as during factory production or at the time of shipment. According to this configuration, it is possible to use a channel map updated to reflect the internal environment of the battery pack 11.

In each of the embodiments and modifications described above, wireless communication may be performed at a predetermined timing, and a channel map updated based on a communication result of the wireless communication may be stored as an updated channel map for use in a subsequent wireless communication. The predetermined timing is preferably, for example, a timing in an environment where external noise is constant or low, such as during factory production or during a long period of parking. According to this configuration, the channel map updated to reflect the internal environment of the battery pack 11 can be used in the subsequent wireless communication.

In each of the embodiments and modifications described above, the communication quality of a communication channel for connection establishment may be determined, and a channel map in which whether the communication channel is usable or not is set may be stored.

The above-described embodiments and modifications thereof may also be implemented in combination within a combinable range. For example, the first embodiment (and modifications thereof, the same applies hereinafter) may be combined with any two or more of the second embodiment (and modifications thereof, the same applies hereinafter) to the sixth embodiment (and modifications thereof, the same applies hereinafter), or all of the embodiments may be combined.

Hereinafter, characteristic configurations extracted from the respective embodiments described above will be described.

### Configuration 1

A battery monitoring system (100) for monitoring battery units by transmitting and receiving battery information through wireless communication, the battery monitoring system comprising:

a wireless apparatus (30, 40) configured to transmit and receive information through wireless communication using a communication channel selected from among a plurality of communication channels; and a storage apparatus (44) configured to store a channel map in which usability of each of the plurality of communication channels is set, wherein the wireless apparatus is configured to update the channel map based on a communication result obtained during the wireless communication and to store the updated channel map into the storage apparatus; and the wireless apparatus is configured to acquire the updated channel map stored in the storage apparatus at an activation of the wireless communication and select the communication channel with reference to the updated channel map.

### Configuration 2

The battery monitoring system according to configuration 1, wherein

the wireless apparatus is configured to execute, before the start of the wireless communication, a connection process for establishing a connection, to perform, during the wireless communication, data communication for transmitting and receiving data related to battery information, and to execute, when terminating the wireless communication, a disconnection process for disconnecting the established connection; and

the wireless apparatus is configured to acquire the updated channel map stored in the storage apparatus during a period from a start of the connection process to before a start of the data communication.

### Configuration 3

The battery monitoring system according to configuration 2, wherein in the connection process, one of a secondary apparatus (30) and a primary apparatus (40) among the plurality of wireless apparatuses transmits a connection request signal to the other, and when the connection request signal is transmitted and received, a connection is established between the primary apparatus and the secondary apparatus; and the wireless apparatus is configured to acquire the updated channel map stored in the storage apparatus during a period from when the connection request signal is transmitted and received to completion of establishment of the connection.

### Configuration 4

The battery monitoring system according to configuration 2, wherein the wireless apparatus is configured such that, when a disconnection request signal is received during the data communication, the wireless apparatus terminates the data communication and starts the disconnection process; and the updated channel map is stored in the storage apparatus during a period from after the disconnection request signal is received to when the connection is disconnected in the disconnection process.

### Configuration 5

The battery monitoring system according to any one of configurations 1 to 4, wherein when a communication abnormality occurs during the wireless communication, a channel map updated during the wireless communication is not stored in the storage apparatus.

### Configuration 6

The battery monitoring system according to any one of configurations 1 to 5, wherein the wireless apparatus does not store, in the storage apparatus, a channel map updated during the wireless communication when the number of communication channels set to be usable in the updated channel map becomes less than or equal to a predetermined threshold during the wireless communication.

### Configuration 7

The battery monitoring system according to any one of configurations 1 to 6, wherein the wireless apparatus refers to an initialized channel map in a next wireless communication when a communication abnormality occurs during the wireless communication or when the number of communication channels set to be usable in an updated channel map becomes less than or equal to a predetermined threshold, or when an updated channel map is not stored in the storage apparatus.

### Configuration 8

The battery monitoring system according to any one of configurations 1 to 7, wherein the battery monitoring system is mounted on a vehicle (10); and the wireless apparatus stores, in the storage apparatus, only a channel map updated while the vehicle is stopped.

### Configuration 9

The battery monitoring system according to any one of configurations 1 to 8, wherein a primary apparatus among the plurality of wireless apparatuses is configured to store the updated channel map in the storage apparatus, and to read the updated channel map stored in the storage apparatus at a start of the wireless communication and transmit the read updated channel map to secondary apparatuses among the plurality of wireless apparatuses.

### Configuration 10

The battery monitoring system according to configuration 9, wherein the channel map is provided for each of the plurality of secondary apparatuses; and the primary apparatus updates the channel map for each of the plurality of secondary apparatuses and stores the updated channel maps separately for each of the plurality of secondary apparatuses.

### Configuration 11

The battery monitoring system according to any one of configurations 1 to 10, wherein the wireless apparatus starts the wireless communication when the battery monitoring system is activated, and terminates the wireless communication when the battery monitoring system stops during the wireless communication.

### Configuration 12

The battery monitoring system according to any one of configurations 1 to 11, wherein the storage apparatus is a main storage apparatus (44) capable of retaining a stored channel map even while the battery monitoring system is stopped, and the wireless apparatus includes a cache memory (32a, 42a) capable of temporarily storing data; and at a start of the wireless communication, the wireless apparatus stores the read updated channel map into the cache memory, updates the channel map stored in the cache memory based on communication results while referring to the channel map during the wireless communication, and stores the updated channel map updated in the cache memory into the main storage apparatus when terminating the wireless communication.

### Configuration 13

The battery monitoring system according to any one of configurations 1 to 12, wherein when the number of the wireless apparatuses or an arrangement of the wireless apparatuses is changed, or when any one of the plurality of wireless apparatuses is replaced with another wireless apparatus, the communication channel is selected with reference to an initialized channel map at a start of the wireless communication.

### Configuration 14

A wireless communication program for causing a wireless apparatus (30, 40) in a battery monitoring system (100) to perform wireless communication, the battery monitoring system including the wireless apparatus configured to transmit and receive information by wireless communication using a communication channel selected from among a plurality of communication channels, and a storage apparatus (44) configured to store a channel map in which an usability of the plurality of communication channels is set, the battery monitoring system transmitting and receiving battery information by the wireless communication to monitor battery units (20, 21, 22), the wireless communication program causing the wireless apparatus to perform:

an updating process of updating the channel map based on a communication result during the wireless communication;

a storing process of storing, in the storage apparatus, an updated channel map updated by the updating process;

an acquiring process of acquiring, at a start of the wireless communication, the updated channel map stored in the storage apparatus; and

a selecting process of selecting a communication channel with reference to the updated channel map acquired by the acquiring process.

### Configuration 15

A wireless communication method performed by a wireless apparatus (30, 40) in a battery monitoring system (100) for monitoring battery units (20, 21, 22) by transmitting and receiving battery information through wireless communication, the battery monitoring system including the wireless apparatus configured to transmit and receive information through wireless communication using a communication channel selected from among a plurality of communication channels, and a storage apparatus (44) configured to store a channel map in which usability of each of the plurality of communication channels is set, the method comprising steps:

updating the channel map based on a communication result obtained during the wireless communication;

storing the updated channel map into the storage apparatus;

acquiring the updated channel map stored in the storage apparatus at an activation of the wireless communication; and

selecting the communication channel with reference to the updated channel map.

The control unit and the method thereof described in the present disclosure may be implemented by a dedicated computer provided by configuring a processor and a memory programmed to execute one or more functions embodied by a computer program. Alternatively, the control unit and the method thereof described in the present disclosure may be implemented by a dedicated computer provided by configuring a processor with one or more dedicated hardware logic circuits. Alternatively, the control unit and the method thereof described in the present disclosure may be implemented by one or more dedicated computers configured by a combination of a processor and a memory programmed to execute one or more functions and a processor configured by one or more hardware logic circuits. Further, the computer program may be stored, as instructions executed by a computer, in a non-transitory tangible computer-readable recording medium.

The present disclosure has been described in accordance with the embodiments. However, the present disclosure is not limited to the embodiments and structure thereof. The present disclosure includes various modification examples and modifications within the equivalent configurations. Further, various combinations and modes and other combinations and modes including one element or more or less elements of those various combinations are within the range and technical scope of the present disclosure.

### Conclusion

The present disclosure provides a battery monitoring system, a wireless communication program, and a wireless communication method capable of reducing communication errors.

A first aspect for solving the above-described issue provides a battery monitoring system for monitoring battery units by transmitting and receiving battery information through wireless communication, the battery monitoring system including a wireless apparatus configured to transmit and receive information through wireless communication using a communication channel selected from among a plurality of communication channels, and a storage apparatus configured to store a channel map in which usability of each of the plurality of communication channels is set. The wireless apparatus is configured to update the channel map based on a communication result obtained during the wireless communication and to store the updated channel map in the storage apparatus. At an activation of the wireless communication, the wireless apparatus acquires the updated channel map stored in the storage apparatus and selects the communication channel with reference to the updated channel map.

According to this configuration, at an activation of the wireless communication, the updated channel map is acquired, and the communication channel is selected with reference to the updated channel map. Therefore, at the start of the wireless communication, the communication channel can be appropriately selected with reference to the channel map reflecting the communication result of the previous wireless communication, thereby reducing communication errors.

A second means for solving the above problem provides a wireless communication program for causing a wireless apparatus in a battery monitoring system to perform wireless communication, the battery monitoring system including the wireless apparatus configured to transmit and receive information through wireless communication using a communication channel selected from among a plurality of communication channels, and a storage apparatus configured to store a channel map in which usability of each of the plurality of communication channels is set, the battery monitoring system transmitting and receiving battery information through the wireless communication to monitor battery units. The wireless communication program causes the wireless apparatus to perform an updating process of updating the channel map based on a communication result obtained during the wireless communication, a storing process of storing the updated channel map updated by the updating process in the storage apparatus, an acquiring process of acquiring the updated channel map stored in the storage apparatus at an activation of the wireless communication, and a selecting process of selecting the communication channel with reference to the updated channel map acquired by the acquiring process.

According to this configuration, at an activation of the wireless communication, the updated channel map is acquired, and the communication channel is selected with reference to the updated channel map. Therefore, at the start of the wireless communication, the communication channel can be appropriately selected with reference to the channel map reflecting the communication result of the previous wireless communication, thereby reducing communication errors.

A third means for solving the above problem provides a wireless communication method performed by a wireless apparatus in a battery monitoring system, the battery monitoring system including the wireless apparatus configured to transmit and receive information through wireless communication using a communication channel selected from among a plurality of communication channels, and a storage apparatus configured to store a channel map in which usability of each of the plurality of communication channels is set, the battery monitoring system transmitting and receiving battery information through the wireless communication to monitor battery units. The wireless communication method includes an updating process of updating the channel map based on a communication result obtained during the wireless communication, a storing process of storing the updated channel map updated by the updating process in the storage apparatus, an acquiring process of acquiring the updated channel map stored in the storage apparatus at an activation of the wireless communication, and a selecting process of selecting the communication channel with reference to the updated channel map acquired by the acquiring process.

According to this method, at an activation of the wireless communication, the updated channel map is acquired, and the communication channel is selected with reference to the updated channel map. Therefore, at the start of the wireless communication, the communication channel can be appropriately selected with reference to the channel map reflecting the communication result of the previous wireless communication, thereby reducing communication errors.

What is claimed is:

1. A battery monitoring system for monitoring battery units by transmitting and receiving battery information through wireless communication, the battery monitoring system comprising:
a wireless apparatus configured to transmit and receive information through wireless communication using a communication channel selected from among a plurality of communication channels; and
a storage apparatus configured to store a channel map in which usability of each of the plurality of communication channels is set,
wherein
the wireless apparatus is configured to update the channel map based on a communication result obtained during the wireless communication and to store the updated channel map into the storage apparatus; and
the wireless apparatus is configured to acquire the updated channel map stored in the storage apparatus at an activation of the wireless communication and select the communication channel with reference to the updated channel map.

2. The battery monitoring system according to claim 1,
wherein
the wireless apparatus is configured to execute, before the start of the wireless communication, a connection process for establishing a connection, to perform, during the wireless communication, data communication for transmitting and receiving data related to battery information, and to execute, when terminating the wireless communication, a disconnection process for disconnecting the established connection; and
the wireless apparatus is configured to acquire the updated channel map stored in the storage apparatus during a period from a start of the connection process to before a start of the data communication.

3. The battery monitoring system according to claim 2,
wherein
in the connection process, one of a secondary apparatus and a primary apparatus among the plurality of wireless apparatuses transmits a connection request signal to the other, and when the connection request signal is transmitted and received, a connection is established between the primary apparatus and the secondary apparatus; and
the wireless apparatus is configured to acquire the updated channel map stored in the storage apparatus during a period from when the connection request signal is transmitted and received to completion of establishment of the connection.

4. The battery monitoring system according to claim 2,
wherein
the wireless apparatus is configured such that, when a disconnection request signal is received during the data communication, the wireless apparatus terminates the data communication and starts the disconnection process; and
the updated channel map is stored in the storage apparatus during a period from after the disconnection request signal is received to when the connection is disconnected in the disconnection process.

5. The battery monitoring system according to claim 1,
wherein
when a communication abnormality occurs during the wireless communication, a channel map updated during the wireless communication is not stored in the storage apparatus.

6. The battery monitoring system according to claim 1,
wherein
the wireless apparatus does not store, in the storage apparatus, a channel map updated during the wireless communication when the number of communication channels set to be usable in the updated channel map becomes less than or equal to a predetermined threshold during the wireless communication.

7. The battery monitoring system according to claim 1,
wherein
the wireless apparatus refers to an initialized channel map in a next wireless communication when a communication abnormality occurs during the wireless communication or when the number of communication channels set to be usable in an updated channel map becomes less than or equal to a predetermined threshold, or when an updated channel map is not stored in the storage apparatus.

8. The battery monitoring system according to claim 1,
wherein the battery monitoring system is mounted on a vehicle; and
the wireless apparatus stores, in the storage apparatus, only a channel map updated while the vehicle is stopped.

9. The battery monitoring system according to claim 1,
wherein
a primary apparatus among the plurality of wireless apparatuses is configured to store the updated channel map in the storage apparatus, and to read the updated channel map stored in the storage apparatus at a start of the wireless communication and transmit the read updated channel map to secondary apparatuses among the plurality of wireless apparatuses.

10. The battery monitoring system according to claim 9,
wherein
the channel map is provided for each of the plurality of secondary apparatuses;
and
the primary apparatus updates the channel map for each of the plurality of secondary apparatuses and stores the updated channel maps separately for each of the plurality of secondary apparatuses.

11. The battery monitoring system according to claim 1,
wherein
the wireless apparatus starts the wireless communication when the battery monitoring system is activated, and terminates the wireless communication when the battery monitoring system stops during the wireless communication.

12. The battery monitoring system according to claim 1,
wherein
the storage apparatus is a main storage apparatus capable of retaining a stored channel map even while the battery monitoring system is stopped, and the wireless apparatus includes a cache memory capable of temporarily storing data; and
at a start of the wireless communication, the wireless apparatus stores the read updated channel map into the cache memory, updates the channel map stored in the cache memory based on communication results while referring to the channel map during the wireless communication, and stores the updated channel map updated in the cache memory into the main storage apparatus when terminating the wireless communication.

13. The battery monitoring system according to claim 1,
wherein
when the number of the wireless apparatuses or an arrangement of the wireless apparatuses is changed, or when any one of the plurality of wireless apparatuses is replaced with another wireless apparatus, the communication channel is selected with reference to an initialized channel map at a start of the wireless communication.

14. A wireless communication program for causing a wireless apparatus in a battery monitoring system to perform wireless communication, the battery monitoring system including
the wireless apparatus configured to transmit and receive information by wireless communication using a communication channel selected from among a plurality of communication channels, and
a storage apparatus configured to store a channel map in which an usability of the plurality of communication channels is set,
the battery monitoring system transmitting and receiving battery information by the wireless communication to monitor battery units, the wireless communication program causing the wireless apparatus to perform:
an updating process of updating the channel map based on a communication result during the wireless communication;
a storing process of storing, in the storage apparatus, an updated channel map updated by the updating process;
an acquiring process of acquiring, at a start of the wireless communication, the updated channel map stored in the storage apparatus; and
a selecting process of selecting a communication channel with reference to the updated channel map acquired by the acquiring process.

15. A wireless communication method performed by a wireless apparatus in a battery monitoring system for monitoring battery units by transmitting and receiving battery information through wireless communication, the battery monitoring system including the wireless apparatus configured to transmit and receive information through wireless communication using a communication channel selected from among a plurality of communication channels, and a storage apparatus configured to store a channel map in which usability of each of the plurality of communication channels is set, the method comprising steps:
updating the channel map based on a communication result obtained during the wireless communication;
storing the updated channel map into the storage apparatus;
acquiring the updated channel map stored in the storage apparatus at an activation of the wireless communication; and
selecting the communication channel with reference to the updated channel map.
